(19) United States
(12) Patent Application Publication
(10) Pub. No.: US 2008/0015871 A1
(43) Pub. Date: Jan. 17, 2008

(54) Varr system

(76) Inventor: Jeff Scott Eder, Mill Creek, WA (US)

Correspondence Address: ASSET TRUST, INC., 2020 MALTBY ROAD, SUITE 7362, BOTHELL, WA, 98021, US

(21) Appl. No.: 10/861,014

(22) Filed: Jun. 3, 2004

Related U.S. Application Data
(63) Continuation of application No. 10/124,237, filed on Apr. 18, 2002, now abandoned.
(60) Provisional application No. 60/531,638, filed on Dec. 22, 2003.

(51) Int. Cl. G06Q 10/00

(52) U.S. Cl. 705/1

(57) ABSTRACT

A method, system and media for learning, analyzing, managing and/or optimizing one or more aspects of organization value, risk and return (VARR) directly and indirectly through the use of narrow systems.

### BACKGROUND OF THE INVENTION

This invention relates to a method, system and media for learning, analyzing, managing and/or optimizing one or more aspects of organization value, risk and return (VARR) directly and indirectly through the use of narrow systems.

### SUMMARY OF THE INVENTION

It is a general object of the present invention to provide a novel and useful system for flexibly integrating and learning from the data, information, knowledge and narrow systems associated with an organization in order to develop an overall system for measuring, managing and/or optimizing one or more aspects of value, risk and return (VARR). A partial list of the different types of narrow systems is shown in Table 1 below.

TABLE 1

| | |
|---|---|
| 1. | Alliance management systems |
| 2. | Asset management systems for capital and IT assets |
| 3. | Brand management systems |
| 4. | Business intelligence systems |
| 5. | Call management systems |
| 6. | Channel management systems |
| 7. | Content management systems |
| 8. | Contract management systems |
| 9. | Customer relationship management systems |
| 10. | Demand chain systems |
| 11. | Email management systems |
| 12. | Employee relationship management systems |
| 13. | Energy risk management systems |
| 14. | Fraud management systems |
| 15. | Incentive management systems |
| 16. | Innovation management systems |
| 17. | Intellectual property management systems |
| 18. | Investor relationship management systems |
| 19. | Knowledge management systems |
| 20. | Location management systems |
| 21. | Maintenance management systems |
| 22. | Partner relationship management systems |
| 23. | Performance management systems (for IT assets) |
| 24. | Price optimization systems |
| 25. | Private exchanges |
| 26. | Product life-cycle management systems |
| 27. | Project portfolio management systems |
| 28. | Risk simulation systems |
| 29. | Sales force automation systems |
| 30. | Scorecard systems |
| 31. | Service management systems |
| 32. | Six-sigma quality management systems |
| 33. | Supplier relationship management systems |
| 34. | Support chain systems |
| 35. | Technology chain systems |
| 36. | Unstructured data management systems |
| 37. | Visitor (web site) relationship management systems |
| 38. | Weather risk management systems |
| 39. | Workforce management systems |
| 40. | Yield management systems |

The systems in Table 1 come on top of new versions of the traditional systems that many companies have had in place for some time including those shown in Table 2 below.

TABLE 2

| | |
|---|---|
| 1. | Basic financial system like a general ledger* |
| 2. | Budgeting/financial planning system |
| 3. | Cash management system |
| 4. | Commodity risk management systems |
| 5. | Credit-risk management system |
| 6. | Human resource management system* |
| 7. | Interest rate risk management system |
| 8. | Material requirement planning system* |
| 9. | Process management systems |
| 10. | Project management systems |
| 11. | Risk management information system |
| 12. | Strategic planning system |
| 13. | Supply chain system |

*all 3 applications are usually bundled within an enterprise resource planning system

Collectively the systems in tables 1 and 2 will be referred to as the “narrow systems”.

An object to which the present invention is applied is flexibly integrating some combination of organization systems, data, information and/or knowledge to support the measurement, management and optimization of some or all of the assets, processes, projects and/or risks associated with the operation of a commercial organization.

Information systems are generally most valuable when they are aligned with the goals of the corporation they serve. Given that the goal of virtually every modern corporation is to improve its financial performance and maximize shareholder value, a system that provides a framework for measuring and optimizing financial performance is also an ideal framework for integrating data, information, knowledge and systems. This specific framework can also be used to integrate the information and knowledge from different parts of the organization to formulate budgets and complete long term plans. In one embodiment, the VARR system (100) utilizes a market value matrix (also referred to as the matrix) as this framework.

In a more general sense, establishing a model that serves as a platform for flexibly integrating some combination of data, information, systems and knowledge from external partners and others in the organization is a new and novel way for coordinating, controlling and improving the productivity of knowledge workers—both internal and external. For example, a model for brand development could be established and then data, information, systems and knowledge that support brand development identified could be flexibly integrated by using the brand development model as the framework for development of an xml schema or ontology that directs data, information, systems and knowledge to the appropriate location within the framework. The same process can be used for any cell or cell subcategory within the market value matrix.

An important general feature of the matrix is that its performance generally improves as more narrow systems are integrated. As systems are added, system flexibility is demonstrated by the fact that there is no specific order in which narrow systems need to be integrated. Another aspect of system flexibility is that the narrow systems do not have to be completely integrated in order to improve the performance of the system. If narrow system operators choose to limit the integration of data from their system(s), then the system of the present invention can still function effectively.

Integrating data, information and knowledge from narrow systems and knowledge bases to the framework defined by a market value matrix starts by establishing a standard data dictionary for account numbers, derived data, element of value, enterprise designations, external factor descriptions, features, risk descriptions and units of measure. The data dictionary will be used for all data being processed within the system of the present invention so all data extracted for use in the system is first converted to the organization standard data dictionary (if necessary) before being stored and/or identified in an application database.

After the data dictionary is established, the next stage in system integration is to define the segments of value and elements of value that define the market value matrix. Commercial businesses can create value in five distinct ways:
1. selling products or services that generate positive cash flow;
2. developing real options for generating positive cash flow in the future;
3. holding investments that produce income and/or capital gains;
4. holding derivatives (broadly defined) that produce income and/or capital gains; and
5. generating positive market sentiment.

These five methods for creating value define the segments of value. When they are added together, the value of these five segments equals the market value of the enterprise or organization.

Separating the segments of value is important for a variety of reasons. Because each segment of value represents a different way to create value, the methods for valuing each segment are different. The risks associated with each of the segments of value are also very different. For example, financial assets like money in the bank and bonds are far more stable than derivatives that are highly leveraged. Derivatives can change in value by many orders of magnitude in an instant. Having said that, it is worth noting that many types of risk can have an impact on every segment of value. For example, catastrophic event risk, like the risk of a large hurricane or terrorist attack, can have an impact on all segments of value. In a similar fashion external factor variability risk and strategic risk, can impact all segments of value. The impact of element variability risk can have less impact on investments and derivatives than the preceding two types of risk. The final type of risk, market volatility is defined as the difference between the overall market risk of equity for the firm (i.e. volatility implied by equity option prices) and the calculated total of the other types of risk.

The first step in defining the framework for enterprise system integration is defining the segments of value for the enterprise. The five segments of value define one axis of the market value matrix. The basic outline of the market value matrix will be completed after specifying the elements of value that define the other axis of the matrix. It is worth noting here that the external factors and risks that can not be assigned to a specific element of value are included in the “Going Concern Value” element. Using the matrix that has just been defined, the cell or cells in the market value matrix (see FIG. 10) that each of the narrow systems is “managing” can now be specified by designating a segment and an element. For example, the position of a supply chain system could be defined as shown below:
Segment of Value: Expense (12), Element of Value: Supplier (39)

If the organization also had a supplier relationship management system, then the data from that system would in all likelihood be pointed to the same cell. Projects, processes and risks generally impact more than one element of value so the specifications for systems used to manage these subsets of enterprise operations would be expected to include a designation for more than one element of value. Locating each system and knowledge base within the market value matrix is just the first step in integrating all enterprise systems and knowledge into a novel system for value, risk and return management (100).

The second step in defining the integration framework is refining the placement of information within each cell to distinguish between,information related to value and the different types of risk. This categorization is facilitated by adding subcategories to each cell within the market value matrix. A cell is defined by the intersection of the segments and elements of value. The subcategories are shown in Table 3.

TABLE 3
Element subcategories

1. Base Value
2. Element Variability Risk
3. Event Risk
4. Factor Variability Risk
5. Strategic Risk
6. Market Volatility Risk

Using the new subcategories, the position of a supply chain system could be defined more precisely as shown below:
Segment of Value: Expense (12), Element of Value: Supplier (39a, 39b)

This designation would be chosen as the supply chain system has information about the performance of the suppliers. This performance data would be expected to include both standard performance information as well as data regarding variability in performance that may have caused financial distress to the organization. The processing that separates the two subcategories (a and b) from the information provided by the supply chain system will be described later in the detailed specification. Mapping data, information and knowledge to a cell within the market value matrix is the first step in integrating all organization related data, information, knowledge and systems, into the novel system for financial performance measurement, management and optimization.

The next step involves identifying what types of data are being received from the integrated systems. There are two types of data that are received from each system: performance data and feature data. Feature data are described first. Features encapsulate all the different options the asset, option, process, project and/or risk managers have for managing the portion of the organization they are responsible for. For example, factor variability risk associated with fluctuating electricity prices could be minimized by:
1. installing new equipment that requires less electrical power;
2. reducing exposure to electricity prices by entering into long term supply contracts; and/or
3. reducing exposure to electricity prices by purchasing derivatives that “lock-in” price protection for future purchases. These derivatives could include options, swaps, swaptions or collars.

The best choice may be some combination of these 3 different “features”. Feature options (also referred to as options) are options to use a feature in the future. For example, the risk owner could purchase land to install a co-generation plant—giving the enterprise the real option to produce its own electricity at some future date. This real option to produce electricity at a future date could limit the time period which electricity factor variability damaged the enterprise and it would be considered a feature option. As detailed later, the system of the present invention will integrate the enterprise data, information, knowledge and systems in order to select the set of features and feature options that maximize the returns and minimize the risk associated with managing the multi-enterprise organization.

For obvious reasons, the fields containing feature data need to be clearly distinguished from the fields containing transaction data and descriptive data. Because the system of the present invention can also be used to develop budgets and long term plans for the organization, provision is also made for transmitting data of this type. Within the overall feature data classification the separate subcategories of information for each feature as shown in Table 4.

TABLE 4
Feature data subcategories

```
  1. Current value (can be yes or no) at system date
  2. Maximum value
  3. Minimum value
  4. time frame to implement
  5. cost to implement (capital and expense)
  6. Local optimization value and date
  7. Enterprise optimization value and date
  8 - Budget Data
  9 - Long Term Plan Data
10 - Remove element
```

In general the narrow systems and knowledge bases will be providing the system of the present invention with the current value, the range of values (maximum value and minimum value), the time period for implementation and the cost to implement for each feature. The system of the present invention will complete its processing and return the feature set that will optimize the financial performance of the entire enterprise (not just a narrow subset).

Having detailed the method for managing the integration of feature data, the next step is to detail the method for integrating performance data. Performance data includes transaction data and descriptive data. Because many of the systems being integrated have their own analytical capabilities, performance data will also include information derived from transaction data, information derived from descriptive data and information derived from transaction and descriptive data. The derived data would be expected to include: clustered data, statistics regarding the data (trends, standard deviation, covariance, etc.) and performance indicators. The usefulness of the derived data can be limited for the same reason the output from these systems is some times limited—lack of information regarding interaction with other elements and options, failure to consider important classes of risk, inability to consider impact on all segments of value and the absence of a true enterprise perspective. In spite of these limitations, the derived data can in some cases be used in system processing. The use of this derived data eliminates the need for the system of the present invention to repeat the same calculations. Use of the derived data generally requires an understanding of the type of processing that has been completed. As with feature data, performance data includes budget and long term plan data. This information is communicated using the categories shown in Table 5.

TABLE 5

```
Processing Level by Element
  1. Raw Data
  2. Clustered Data
  3. Cluster Criteria
  4. Value Driver Candidate (aka performance indicator)
  5. Composite Variable
  6. Value Driver
  7. Independent, Causal Value Driver
  8. Combination Factor or Element
  9. Vector
10 - segment #. Value for segment #
11 - segment #. Element risk for segment #
12 - segment #. Factor risk for segment #
13 - segment #. Event risk for segment #
14 - segment #. Strategic risk for segment #
15 - segment #. Base market risk for segment #
16 - segment # Market volatility risk for segment #.
17 - Budget Data
18 - Long Term Plan Data
Statistics by Element
aa. Mean
ab. Time Period for Mean
ac. Standard Deviation
ad. Time Period for Standard Deviation
ae. Rolling Quarterly Average
af. Time Period for Rolling Quarterly Average
ag. Market Covariance
ah. Time Period for Market Covariance
ai. Slope
aj. Time Period for Slope
ak. Event risk probability
al. Event risk cost
```

### The categories listed in Table 5 can be expanded or contracted in order to cover all types of risk the company is subject to as well as all the processing, completed by the narrow systems.

In addition to using the standard described above for identifying the knowledge bases, data and the information obtained from narrow systems, this same standard is used when processing data and storing the results of system processing. As a result, information can be accessed at any point by anyone with system access in order to determine the financial status of the multi-company organization and/or the companies within the organization. We will refer to data that has the integration identification information attached to it as “tagged data”. Clearly tagging all processed data can also facilitate the automated delivery of new products and services from financial service providers and other partners.

Implementing the integration method with existing applications can take any of several forms including: pre-programmed templates with specified tag assignments for each narrow system and knowledge base, the use of wizards to guide data tag assignments, extensions to existing xml based standards, rdf based ontologies, the specification of the data tags by knowledge base and narrow system operators in the data they make available for transfer or some combination of the first four options. In one embodiment, the knowledge base and narrow system operators will include the specified tags in the data they make available for transfer and they will identify the matrix cell or cells that their data pertains to in the information made available to others. In one embodiment this information will be integrated with the system of the present invention via a knowledge layer in an operating system and the information and knowledge will be made available to all enterprise systems and to partner systems via the same layer. This integration method can also be implemented by obtaining information from databases—physical or virtual—that contain the integrated data.

While one embodiment of the novel system analyzes element and external factor impacts on all five segments of value, the system can operate: when one or more of the segments of value are missing for one or more enterprises and/or for the organization as a whole. For example, the organization may be a value chain that does not have a market value in which case there will be no market sentiment to evaluate. Another common situation would be a multi-company corporation that has no derivatives in most of the enterprises (or companies) within the overall structure. The system is also capable of analyzing a single enterprise. As detailed later, the segments of value that are present in each enterprise are defined in the system settings table (140). Virtually all public companies will have at least three segments of value: current operation, real options and market sentiment. However, it is worth noting only one segment of value is required per enterprise for operation of the system. Because most corporations have only one traded stock, multi-enterprise (aka multi-company) corporations will generally define an enterprise for the “corporate shell” to account for all market sentiment. This “corporate shell” enterprise can also be used to account for any joint options the different companies within the corporation may collectively possess. The system is also capable of analyzing the value of the organization without considering risk. However, the system needs to complete the value analysis before it can complete the analysis of organization risks.

The innovative system has the added benefit of providing a large amount of detailed information to the organization users concerning both tangible and intangible elements of value by enterprise. Because intangible elements are by definition not tangible, they can not be measured directly. They must instead be measured by the impact they have on their surrounding environment. There are analogies in the physical world. For example, electricity is an “intangible” that is measured by the impact it has on the surrounding environment. Specifically, the strength of the magnetic field generated by the flow of electricity through a conductor turns a shaft in a motor and the torque of the shaft is used to determine the amount of electricity that is being consumed. The system of the present invention measures tangible and intangible elements of value by identifying the attributes that, like the magnetic field, reflect the strength of the element in driving segments of value (current operation, investments, real options, derivatives, market sentiment) and/or components of value (revenue, expense and change in capital) within the current operation and are relatively easy to measure. Once the attributes related to the strength of each element are identified, they can be summarized into a single expression (a vector) if the attributes don't interact with attributes from other elements. If attributes from, one element drive-those from another, then the elements can be combined for analysis and/or the impact of the individual attributes can be summed together to calculate a value for the element. In one embodiment, vectors are used to summarize the impact of the element attributes. The vectors for all elements are then evaluated to determine their relative contribution to driving each of the components of value and/or each of the segments of value. The system of the present invention calculates the product of the relative contribution and the forecast longevity of each element to determine the relative contribution to each of the elements of value to each segment of value. The contribution of each element to each enterprise is then determined by summing the element contribution to each segment of value. The value contribution of external factors is determined using the same process described for element evaluation. The organization value is then calculated by summing the value of all the enterprises within the organization

In accordance with the invention, the automated extraction of data from existing narrow systems and knowledge bases significantly increases the scale and scope of the analysis that can be completed. The system of the present invention further enhances the efficiency and effectiveness of the analysis by automating the retrieval, storage and analysis of data and information useful for analyzing elements of value, segments of value and organization risks from external databases, external publications and the Internet. To facilitate its use as a tool for financial management, the system of the present invention produces intuitive graphical reports and reports in formats that are similar to the reports provided by traditional accounting systems. Integrating information from all enterprise systems is just one way the system of the present invention overcomes the limitations of existing methods and systems.

The method for integrating the data, information and knowledge from the numerous, narrow business management systems provided by the present invention minimizes the need for custom interface development. The system of the present invention can also integrate the narrowly focused enterprise systems and knowledge bases into an overall system for measuring, managing and optimizing organizational financial performance. The level of integration enabled by the system of the present invention can also support: the creation of new financial products; the creation of new financial services; the automated delivery of new financial products and services; the automated delivery of traditional financial products and services; and the integration of narrow systems with other applications.

By providing real-time financial insight to users of every system in the organization, the system of the present invention enables the continuous optimization of management decision making across an entire organization.

### BRIEF DESCRIPTION OF DRAWINGS

These and other objects, features and advantages of the present invention will be more readily apparent from the following description of one embodiment of the invention in which:

FIG. 1 is a block diagram showing the major processing steps of the present invention;

FIG. 2 is a diagram showing the files or tables in the application database (50) of the present invention that are utilized for data storage and retrieval during the processing in the innovative system for multi-enterprise organization analysis and optimization;

FIG. 3 is a block diagram of an implementation of the present invention;

FIG. 4 is a block diagram showing the sequence of steps in the present invention used for specifying system settings and for integrating data, information, knowledge and/or systems;

FIG. 5A, FIG. 5B and FIG. 5C are block diagrams showing the sequence of steps in the present invention used for preparing data obtained from the narrow systems for processing by the system of the present invention;

FIG. 6A, FIG. 6B, FIG. 6C and FIG. 6D are block diagrams showing the sequence of steps in the present invention used for creating, analyzing and optimizing the market value matrix for the organization by enterprise;

FIG. 7 is a block diagram showing the sequence in steps in the present invention used in defining and displaying reports and completing special analyses;

FIG. 8 is a diagram showing the data windows that are used for receiving information from and transmitting information to the user (20) during system processing;

FIG. 9 is a diagram showing how the enterprise matrices of risk can be combined to calculate the organizational matrix of risk; and

FIG. 10 is a diagram showing how the enterprise market value matrices can be combined to calculate the market value matrix for the organization;

FIG. 11 is a sample report showing the efficient frontier for Organization XYZ and the current position of XYZ relative to the efficient frontier and the market frontier; and

FIG. 12 is a sample report showing the efficient frontier for Organization XYZ, the current position of XYZ relative to the efficient frontier and the forecast of the new position of XYZ relative to the efficient frontier after user specified changes are implemented.

### DETAILED DESCRIPTION OF ONE EMBODIMENT

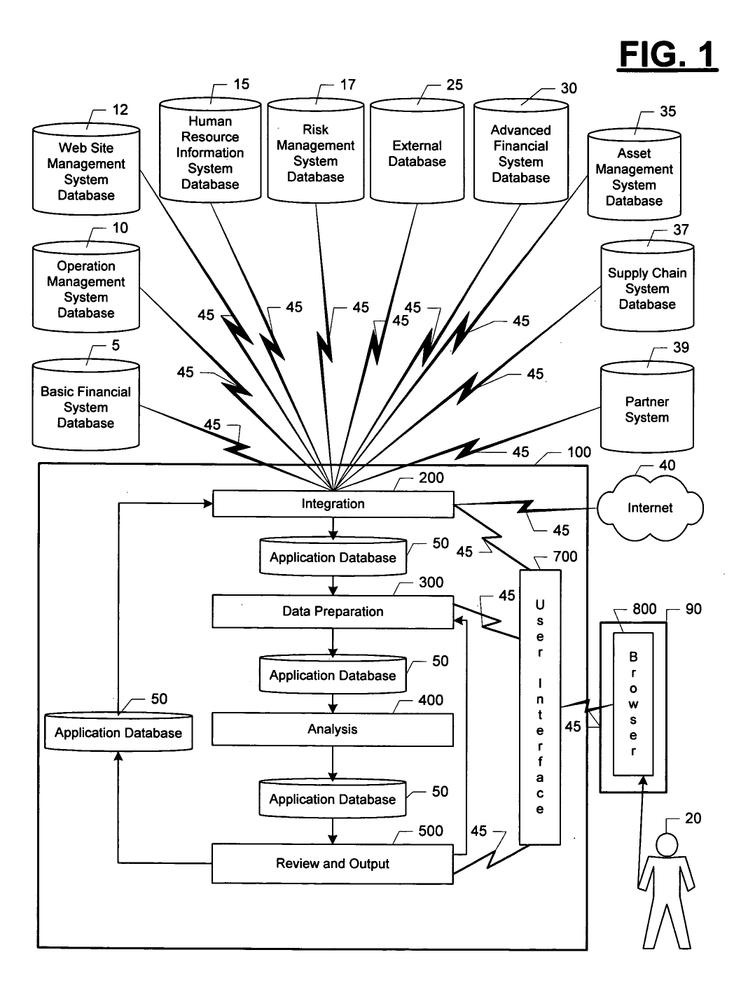

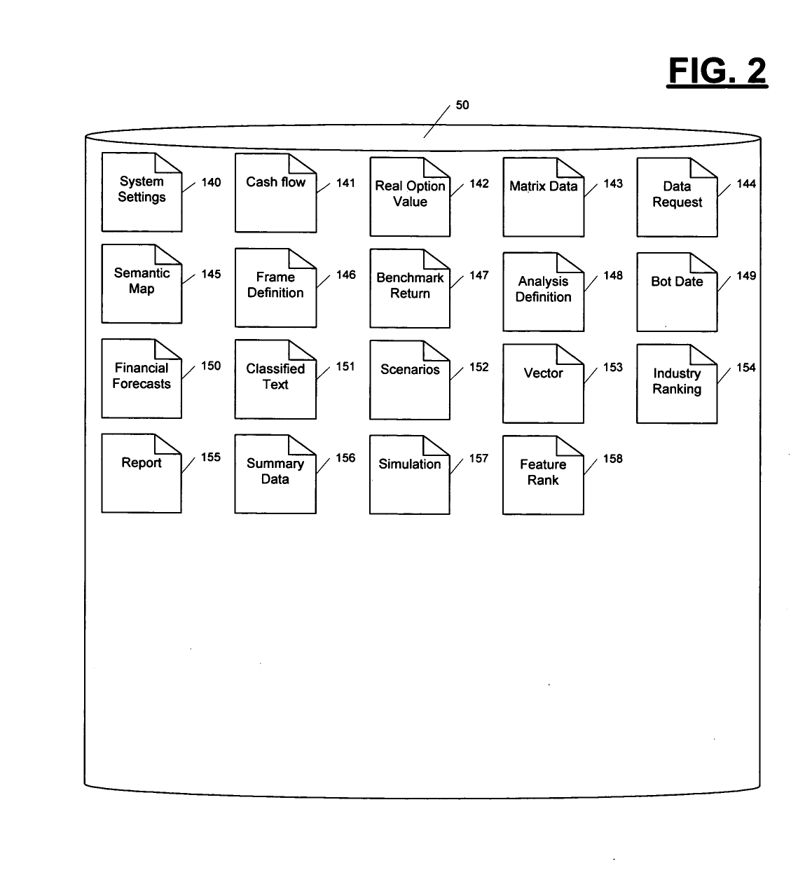

FIG.1 provides an overview of the processing completed by the innovative system for measuring, managing and continuously optimizing one or more cells within the market value matrix for a multi-enterprise organization. In accordance with the present invention, an automated method of and system (100) for identifying the features in the optimal market value matrix for a multi-enterprise commercial organization is provided. Processing starts in this system (100) with the specification of system settings and the flexible integration (200) of the system of the present invention with a basic financial system (5), an operation management system (10), a web site management system (12), a human resource information system (15), a risk management system (17), an external database (25), an advanced financial system (30), an asset management system (35), a supply chain system (37), a knowledge base (36) and a partner system (39) via a network (45). The system integration progress may be influenced by a user (20) through interaction with a user-interface portion of the application software (700) that mediates the display, transmission and receipt of all information to and from browser software (800) such as the Netscape Navigator or the Microsoft Internet Explorer in an access device (90) such as a phone, pda or personal computer where data are entered by the user (20).

While only one system and database of each type (5, 10, 12, 15, 17, 25, 30, 35, 36, 37 and 39) is shown in FIG. 1, it is to be understood that the system (100) can integrate with all narrow systems listed in Tables 1 and 2 and multiple knowledge bases. In one embodiment at least one system of each type listed (5, 10, 12, 15, 17, 25, 30, 35, 36, 37 and 39) will be integrated with the system (100) via the network (45) for each enterprise within the organization. While the data from multiple asset management systems can be utilized in the analysis of each element of value completed by the system of the present invention, one embodiment of the present invention contains only one asset management system for each element of value being analyzed for each enterprise within the organization. Integrating all the asset management systems ensures that every asset—tangible or intangible—is considered within the overall financial framework for the organization. It should also be understood that it is possible to complete a bulk extraction of data from each database (5, 10, 12, 15, 17, 25, 30, 35, 36, 37 and 39) and the Internet (40) via the network (45) using peer to peer networking and data extraction applications before initializing the data bots. The data extracted in bulk could be stored in a single datamart, a data warehouse or a storage area network where the data bots could operate on the aggregated data or the data could be left in the original databases and extracted as needed for calculations by the bots over a network (45).

All extracted information is stored in a file or table (hereinafter, table) within an application database (50) as shown in FIG. 2. The application database (50) contains tables for storing user input, extracted information and system calculations including a system settings table (140), a cash flow table (141), a real option value table (142), a matrix data table (143), a data request table (144), a semantic map table (145), a frame definition table (146), a benchmark return table (147), an analysis definition table (148), a bot date table (149), a financial forecasts table (150), a classified text table (151), a scenarios table (152), a vector table (153), an industry ranking table (154), a report table (155), an summary data table (156), a simulation table (157) and a feature rank table (158).

The application database (50) can optionally exist as a datamart, data warehouse, a virtual repository or storage area network. The system of the present invention has the ability to accept and store supplemental or primary; data directly from user input, a data warehouse or other electronic files in addition to receiving data from the databases described previously. The system of the present invention also has the ability to complete the necessary calculations without receiving data from one or more of the specified databases. However, in one embodiment the information is obtained from the specified data sources (5, 10, 12, 15, 17, 25, 30, 35, 36, 37, 39 and 40) for each enterprise in the organization.

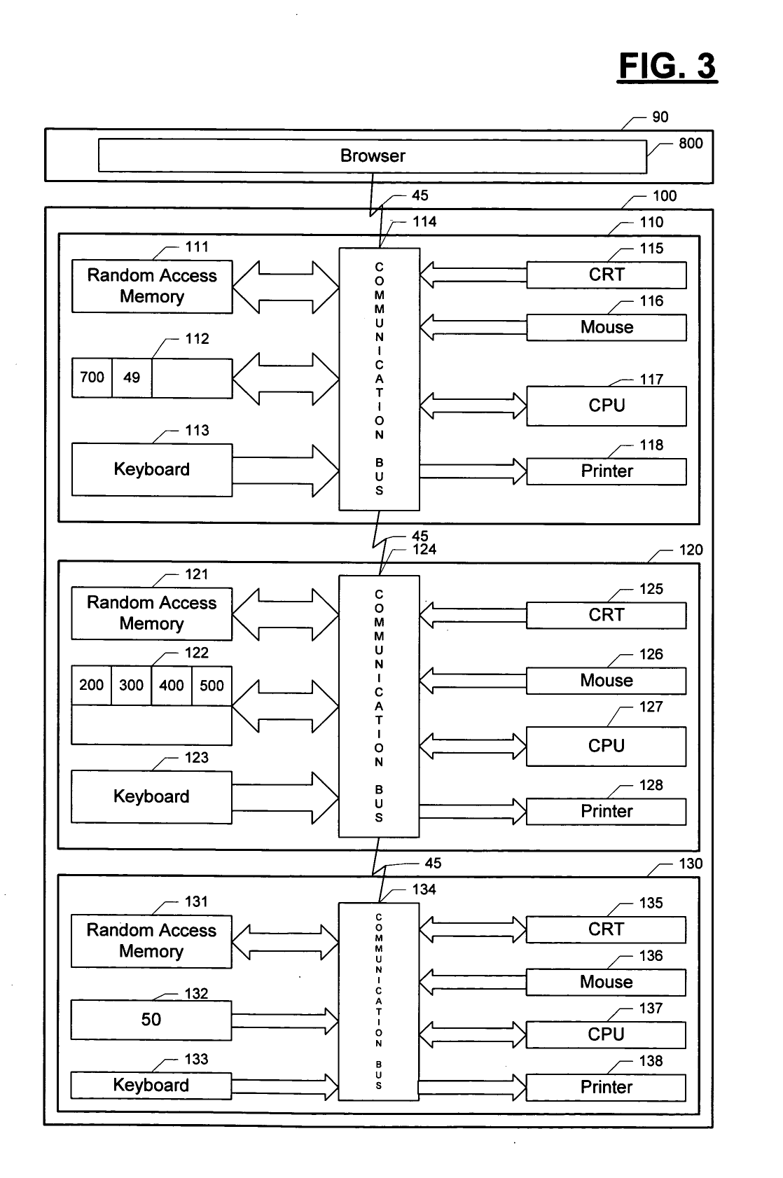

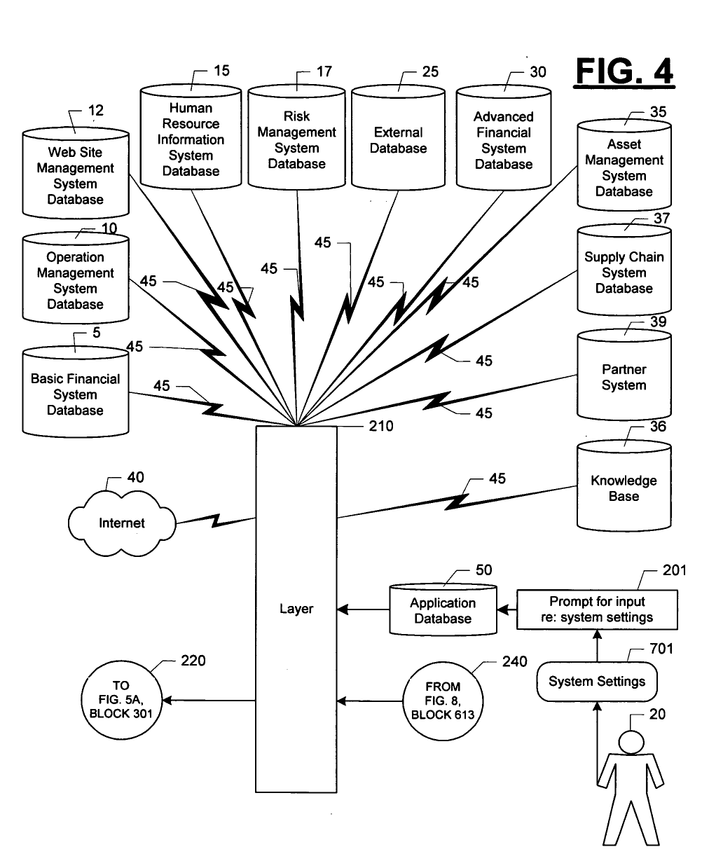

As shown in FIG. 3, one embodiment of the present invention is a computer system (100) illustratively comprised of a user-interface personal computer (110) connected to an application-server personal computer (120) via a network (45). The application-server personal computer (120) is in turn connected via the network (45) to a database-server personal computer (130). The user interface personal computer (110) is also connected via the network (45) to an Internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communication bus (134), a display (135), a mouse (136), a CPU (137) and a printer (138).

The application-server personal computer (120) has a read/write random access memory (121), a hard drive (122) for storage of the non-user-interface portion of the enterprise section of the application software (200, 300, 400 and 500) of the present invention, a keyboard (123), a communication bus (124), a display (125), a mouse (126), a CPU (127) and a printer (128). While only one client personal computer is shown in FIG. 3, it is to be understood that the application-server personal computer (120) can be networked to fifty or more client, user-interface personal computers (110) via the network (45). The application-server personal computer (120) can also be networked to fifty or more server, personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communication bus (114), a display (115), a mouse (116), a CPU (117) and a printer (118).

The application software (200, 300, 400, and 500) controls the performance of the central processing unit (127) as it completes the calculations used to support the production of the market value matrix for a commercial enterprise. In the embodiment illustrated herein, the application software program (200, 300, 400 and 500) is written in a combination of C++, Java and Visual Basic®. The application software (200, 300, 400 and 500) can use Structured Query Language (SQL) for extracting data from the databases and the Internet (5, 10, 12, 15, 17, 25, 30, 35, 36, 37, 39 and 40). The user (20) can optionally interact with the user-interface portion of the application software (700) using the browser software (800) in the browser appliance (90) to provide information to the application software (200, 300, 400 and 500) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120, 130) shown in FIG. 3 illustratively are personal computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (131) and at least a 500 gigabyte hard drive (132).

Using the system described above, the market value matrix is used as a template to guide the integration of the narrowly focused enterprise systems into a system for measuring and optimizing the financial performance of a multi-enterprise organization. The market value matrix is also used as a template to structure the knowledge stored in the organization by enterprise.

In one embodiment, the revenue, expense and capital requirement forecasts for the current operation, the real options and the contingent liabilities are obtained from an advanced financial planning system database (30) derived from an advanced financial planning system similar to the one disclosed in U.S. Pat. No. 5,615,109. The extracted revenue, expense and capital requirement forecasts are used to calculate a cash flow for each period covered by the forecast for each enterprise by subtracting the expense and change in capital for each period from the revenue for each period. A steady state forecast for future periods is calculated after determining the steady state growth rate that best fits the calculated cash flow for the forecast time period. The steady state growth rate is used to calculate an extended cash flow forecast. The extended cash flow forecast is used to determine the Competitive Advantage Period (CAP) implicit in the enterprise market value.

Before going further, we need to define a number of terms that will be used throughout the detailed description of one embodiment:
1) A transaction is any event that is logged or recorded;
2) Transaction data are any data related to a transaction;
3) Descriptive data are any data related to any item, segment of value, element of value, component of value, risk or external factor that is logged or recorded that is not transaction data. Descriptive data includes forecast data and other data calculated by the system of the present invention;
4) An element of value (or element) is “an entity or group that as a result of past transactions, forecasts or other data has provided and/or is expected to provide economic benefit to one or more segments of value of the enterprise”;
5) An item is a single member of the group that defines an element of value. For example, an individual salesman would be an “item” in the “element of value” sales staff. It is possible to have only one item in an element of value;
6) Item variables are the transaction data and descriptive data associated with an item or related group of items;
7) Item performance indicators are data derived from transaction data and/or descriptive data;
8) Composite variables for an element are mathematical or logical combinations of item variables and/or item performance indicators;
9) Element variables or element data are the item variables, item performance indicators and composite variables for a specific element or sub-element of value;
10) External factors (or factors) are numerical indicators of: conditions or prices external to the enterprise and conditions or performance of, the enterprise compared to external expectations of conditions or performance;
11) Factor variables are the transaction data and descriptive data associated with external factors;
12) Factor performance indicators are data derived from factor transaction data and/or descriptive data;
13) Composite factors are mathematical or logical combinations of factor variables and/or factor performance indicators for a factor;
14) Factor data are the factor variables, factor performance indicators and composite factors for external factors;
15) A layer is software and/or information that gives an application or layer the ability to interact with another layer, application or set of information at a general or abstract level rather than at a detailed level, web services are the functional equivalents of layers in a web services environment;
16) An operating system is a program that manages: hardware, other programs, web services, and/or the interaction between any combination of hardware, other programs and web services. For example, a computer operating system manages the interaction between other programs in a computer. In a similar fashion, a network operating system manages the interaction between hardware and applications on a network. The programs and/or hardware make use of the operating system by making requests for services through defined procedures. In addition, users can interact directly with the operating system through a user interface such as a command language or a graphical user interface;
17) An enterprise is a commercial enterprise with one revenue component of value (note: it is possible to define a commercial enterprise that has more than one revenue component of value);
18) A value chain is defined to be enterprises that have joined together to deliver a product and/or a service to a customer;
19) A multi-company corporation is a corporation that participates in more than one distinct line of business. The distinctiveness of a given line of business is determined by the elements of value that support the business. If more than 50% of the elements of value that support a revenue stream are unique to that revenue stream, then that revenue stream defines a “distinct” line of business;
20) Multi enterprise organizations include value chains and multi-company corporations. Partnerships between government agencies and private companies and/or between two government agencies are also defined as multi-enterprise organizations;
21) Frames are sub-sets of an enterprise, sub-sets of a multi-enterprise organization, enterprise combination or organization combination that can be analyzed separately. For example, one frame could group together all the elements, external factors and other risks from the market value matrix package by process allowing different processes to be analyzed by outside vendors. Another frame could exclude the market sentiment segment of value from each enterprise within a multi-enterprise organization. Frames can also be used to collect budget information and long term plan information;
22) Risk is defined as events or variability that may cause losses and/or diminished financial performance for an enterprise or organization;
23) Variability risk is risk of financial damage caused by variability. Variability can be caused by: external factors (i.e. commodity prices, interest rates, exchange rates, ideas, market level, etc.) and elements of value within an enterprise (i.e. processes, equipment, employees, etc.). There is also variability risk associated with the market price of equity for the organization. Variability risk is generally quantified using statistical measures like standard deviation per month, per year or over some other time period. The covariance between different variability risks is also determined as simulations utilize the quantified information regarding the inter-relationship between the different risks;
24) Factor variability (or factor variability risk) is the risk of damage caused by external factor variability;
25) Element variability (or element variability risk) is the risk of damage caused by variability of elements of value;
26) Market variability is defined as the implied variability associated with enterprise or organization equity. The implied amount of this variability can be determined by analyzing the option prices for company equity.
27) Event risk is the risk of financial damage caused by an event. Most insurance policies cover event risks. For example, an insurance policy might state in essence that: if this event happens, then we will reimburse event related expenses up to a pre-determined amount. Event risks that are covered by insurance are typically associated with damage to people and property that are caused by accidents, the weather (hurricanes, tornadoes) and acts of nature (earthquakes, volcanoes, etc.). Other events that can cause damage like customer defection, employee resignation, etc. are generally not covered by insurance and as a result many companies overlook their impact. Event risks are generally tracked using modified database programs that keep track of each occurrence of each type of risk, its cause, cost and the amount of money that was reimbursed. These programs can be used to analyze historical patterns and develop forecasts. The forecasts are often used in forecasting the expected frequency of different events, the cost associated with each event and the associated dollar value of the risk that should be insured;
29) Standard event risks will be defined as those risks that have a one time impact.
30) Strategic risk (or strategic event risk) is the risk associated with events that can have a permanent impact on the financial prospects of an enterprise or organization. Examples of strategic risk would include: the risk that a large new competitor enters the market, the risk of a catastrophe so: large that the company is wiped out and the risk that a new technology renders existing products obsolete;
31) Base market risk is defined as the implied variability associated with a portfolio that represents the market. For example, the S&P 500 can be used in the U.S. and the FTSE 100 can be used in the U.K. The implied amount of this variability can be determined by analyzing the option prices for company equity;
32) Industry market risk is defined as the implied variability associated with a portfolio that is in the same SIC code as the enterprise or organization—industry market risk can be substituted for base market risk in order to get a clearer picture of the market risk specific to the organization (or enterprise) stock;
33) Market volatility (or market risk sentiment), is the different between market variability risk and the calculated values of: base market risk, factor variability, element variability, event risk and strategic event risk over a given time period;
34) Narrow systems are the systems listed in Tables 1 and 2 and any other system that supports the analysis, measurement or management of an element, segment, factor, process or risk of an organization or enterprise;
35) Real options are defined as options the organization may have to make a change in its operation at some future date—these can include the introduction of a new product, the ability to shift production to lower cost environments, etc. Real options are generally supported by the elements of value of an organization;
36) Contingent liabilities are liabilities the organization may have at some future date, the liability is contingent on some event occurring in the future, therefore they can be considered as a type of event risk. However, because they are valued using real option algorithms, they are included in the real option segment of value; and
37) The efficient frontier is defined as the maximum return the organization can expect for a given level of risk. It is similar in concept to the “efficient frontier” from portfolio management theory however it is different in several respects. For example, the efficient frontier for portfolios only identifies the investments that should be in or out of the portfolio to provide the maximum return for a given level of risk. The efficient frontier in the system of the present invention is defined by the feature set for all elements of value, external factors and risks that provides the highest expected return. The efficient frontier for portfolios is determined by making tradeoffs versus a single measure of risk while the efficient frontier defined by the novel system of the present invention makes tradeoffs relative to six different types of risk and other features that are all inter-related.

We will use the terms defined above when detailing one embodiment of the present invention. In this invention, analysis bots are used to determine element of value lives and the percentage of each segment of value that is attributable to each element of value (and external factor) by enterprise. The resulting values are then added together to determine the valuation for each element (and external factor). This process is illustrated by the example in Table 6 for the current operation segment of value (which is divided into 3 components of value—revenue, expense and capital change for more detailed analysis). External factor values are calculated in a similar manner, however, they generally do not have defined lives.

TABLE 6

| | | Element | |
|---|---|---|---|
| Gross Value | Percentage | Life/CAP* | Net Value |
| Revenue value = $120 M | 20% | 80% | Value = $19.2 M |
| Expense value = ($80 M) | 10% | 80% | Value = ($6.4) M |
| Capital value = ($5 M) | 5% | 80% | Value = ($0.2) M |
| Total value = $35 M | | | |
| Net value for this element: | | | Value = $12.6 M |

*CAP = Competitive Advantage Period

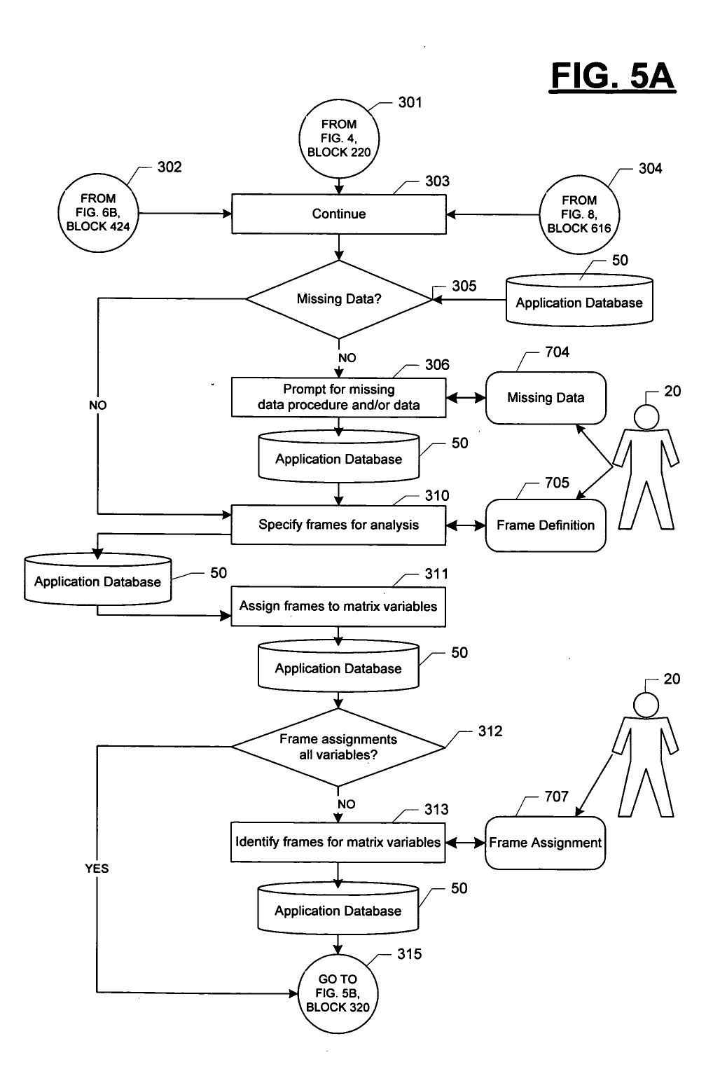

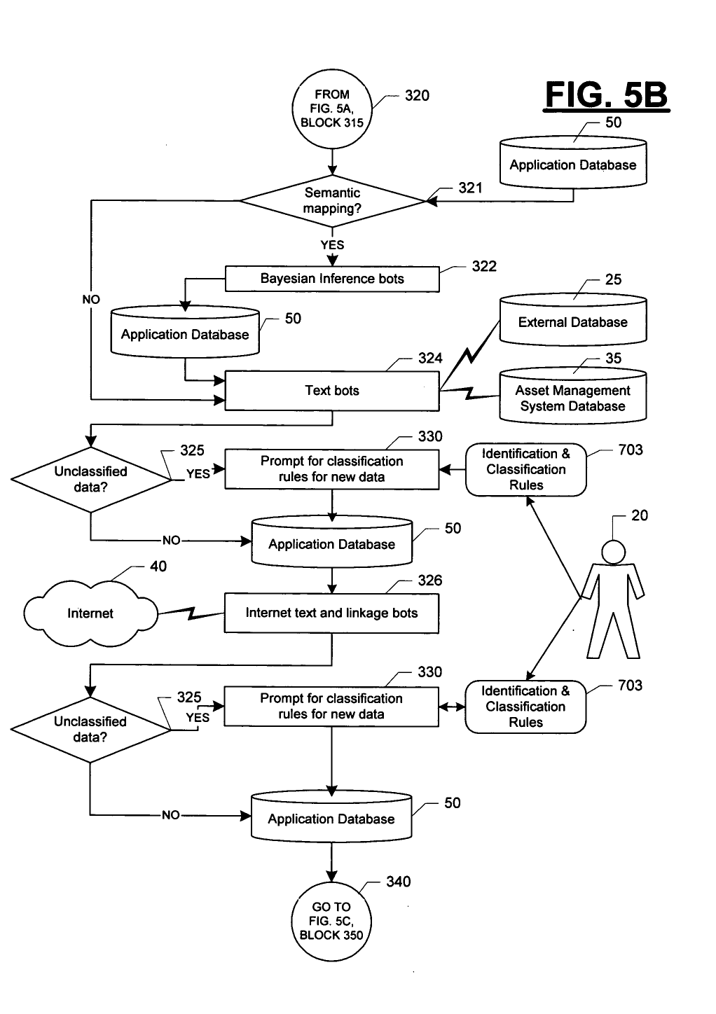

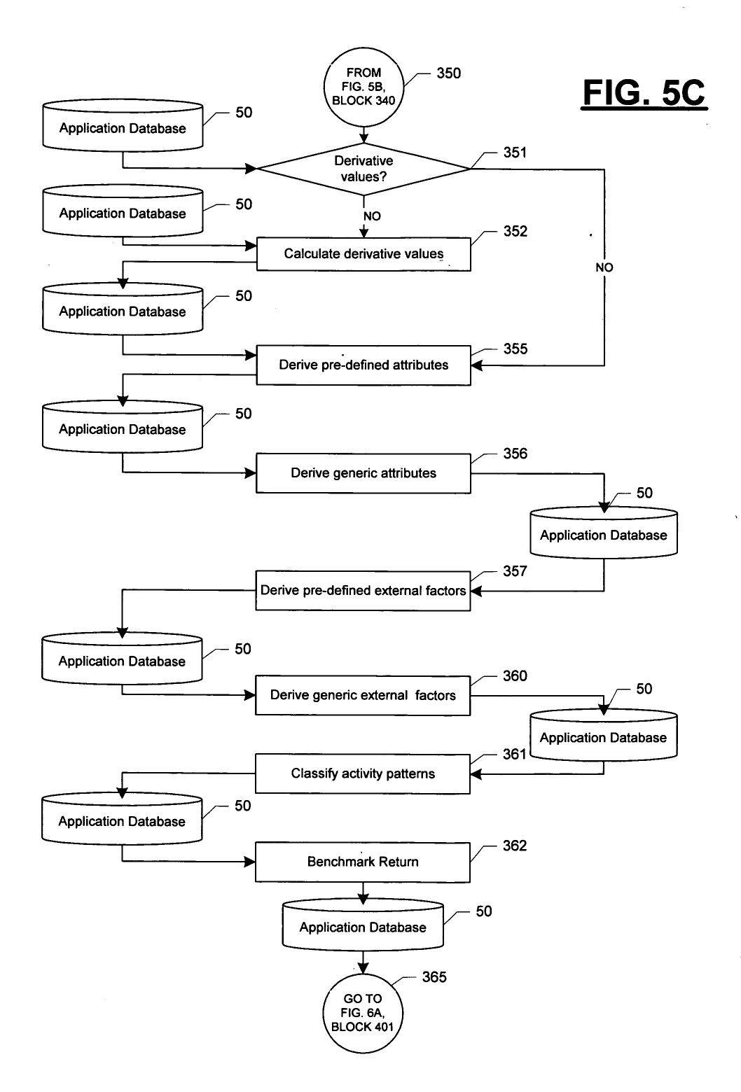

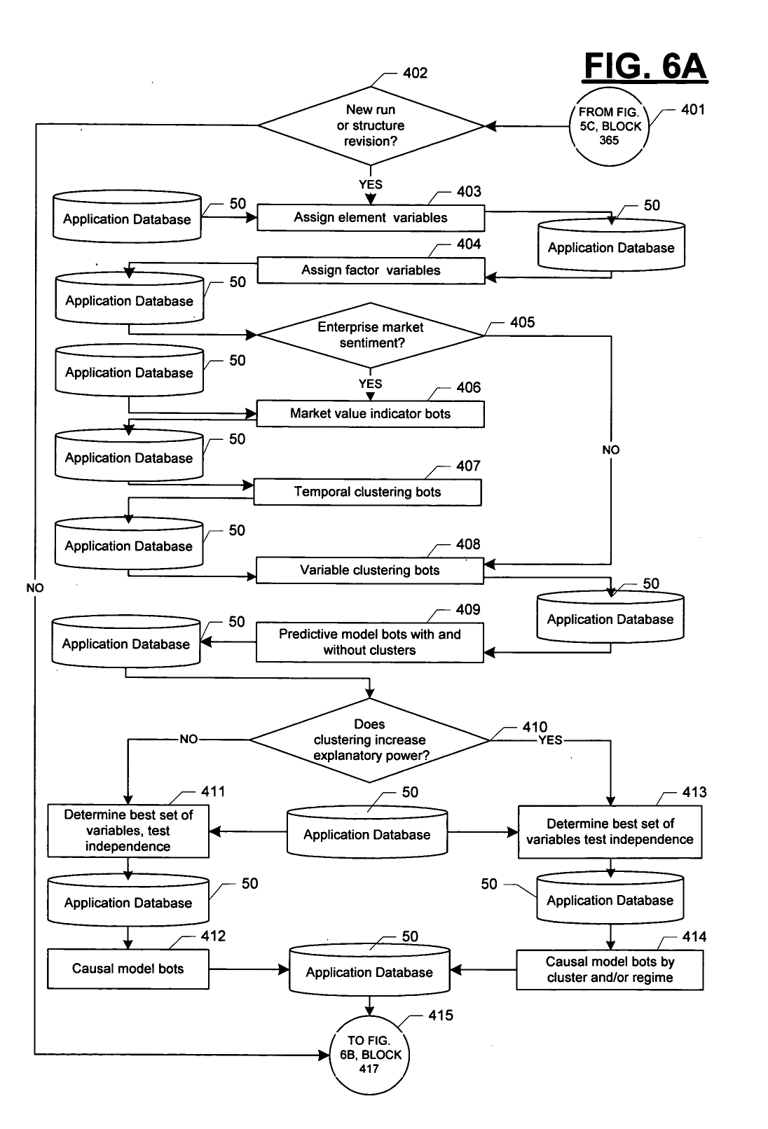

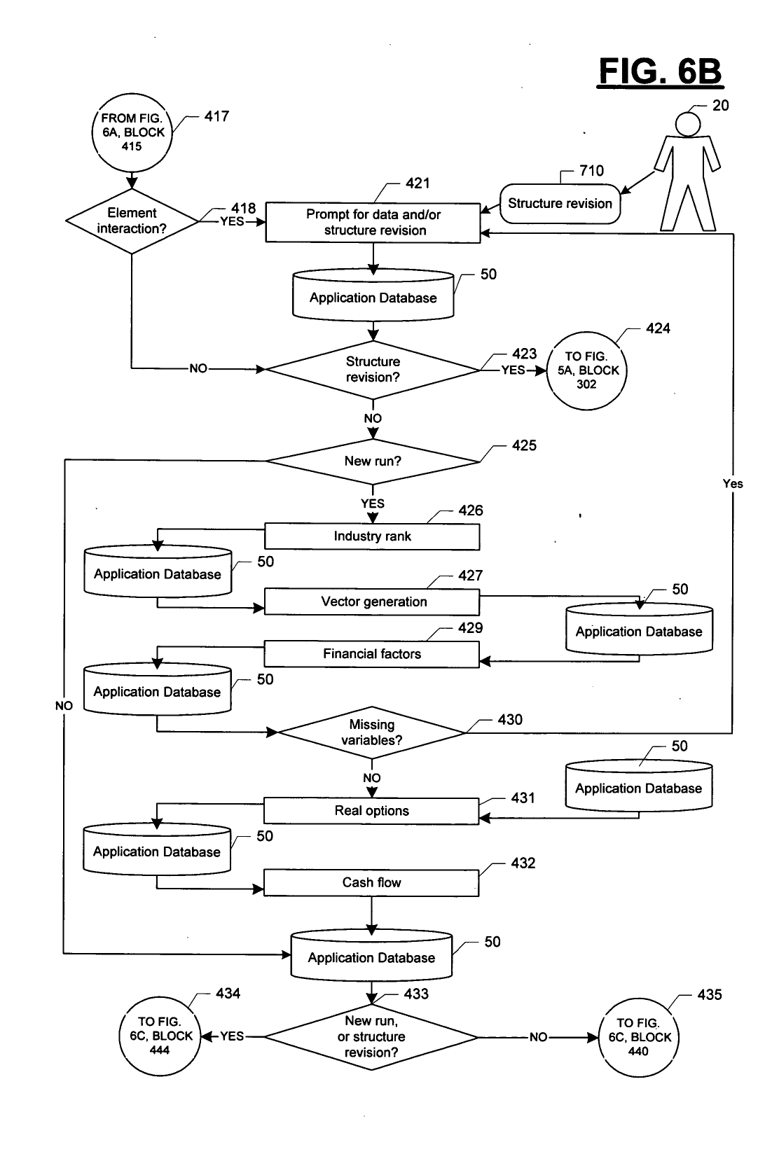

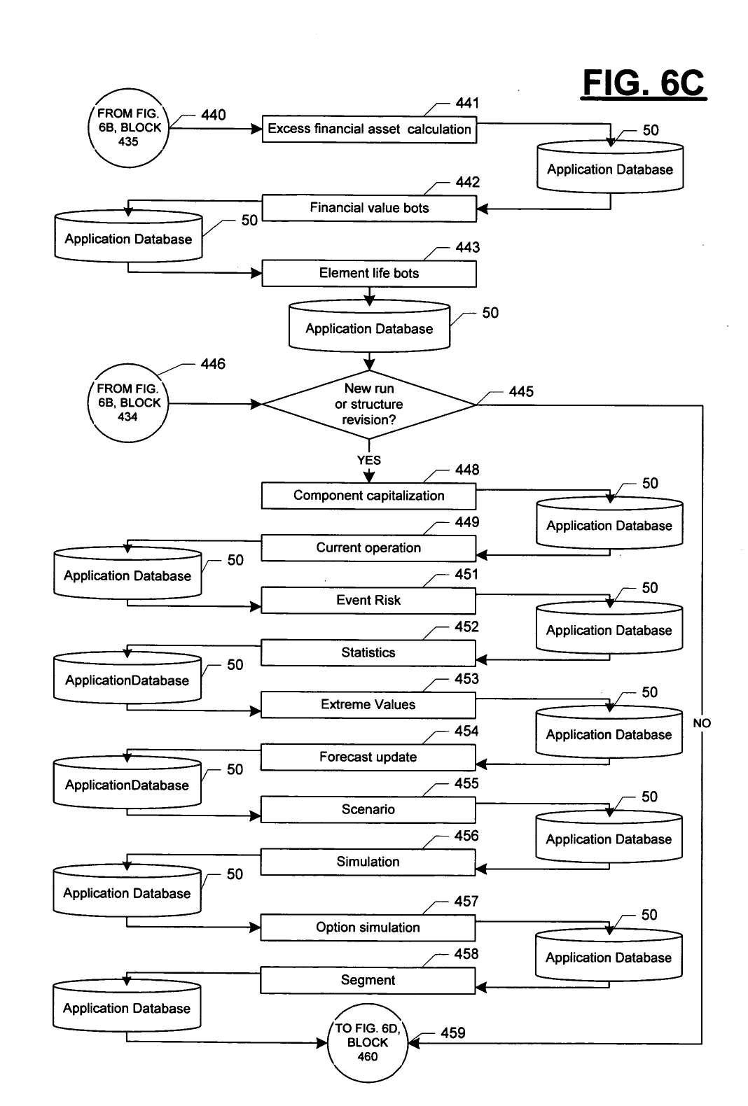

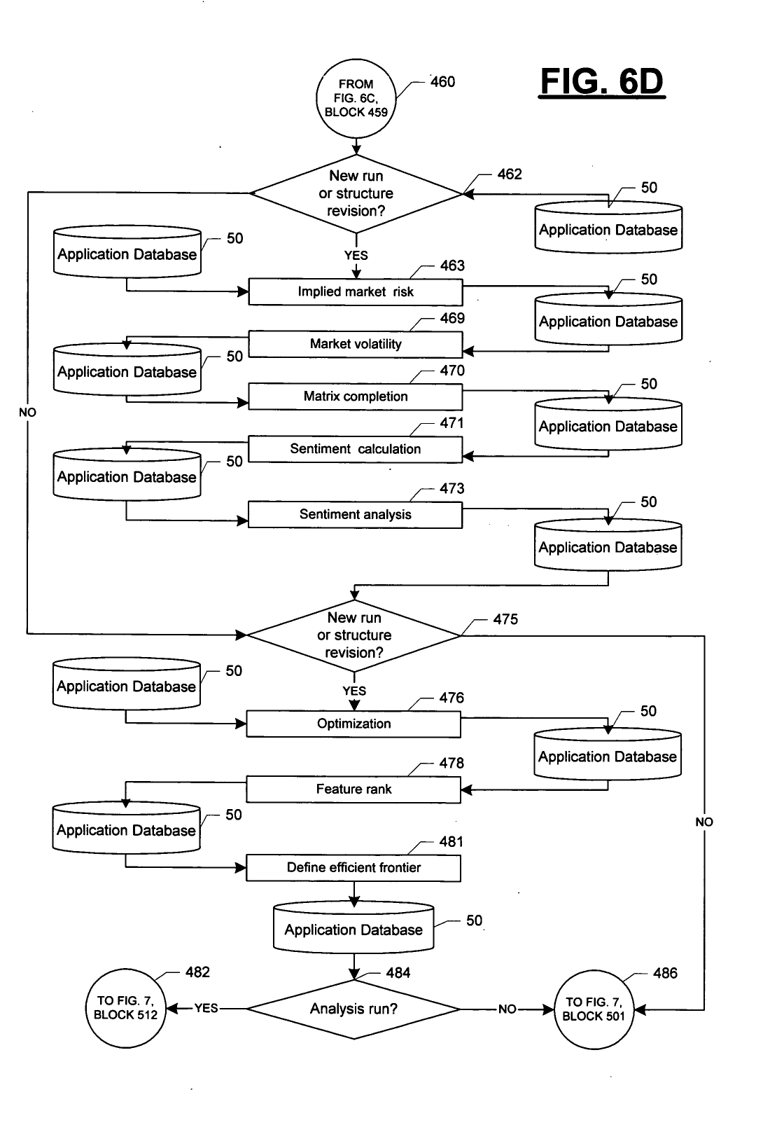

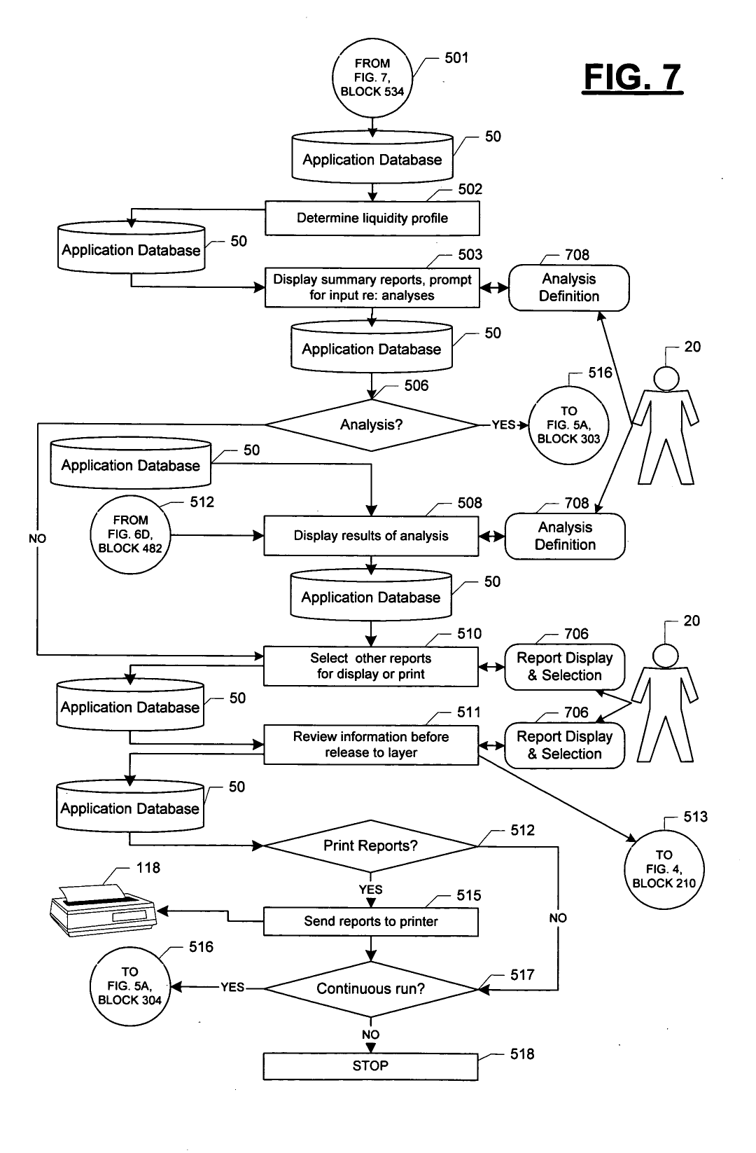

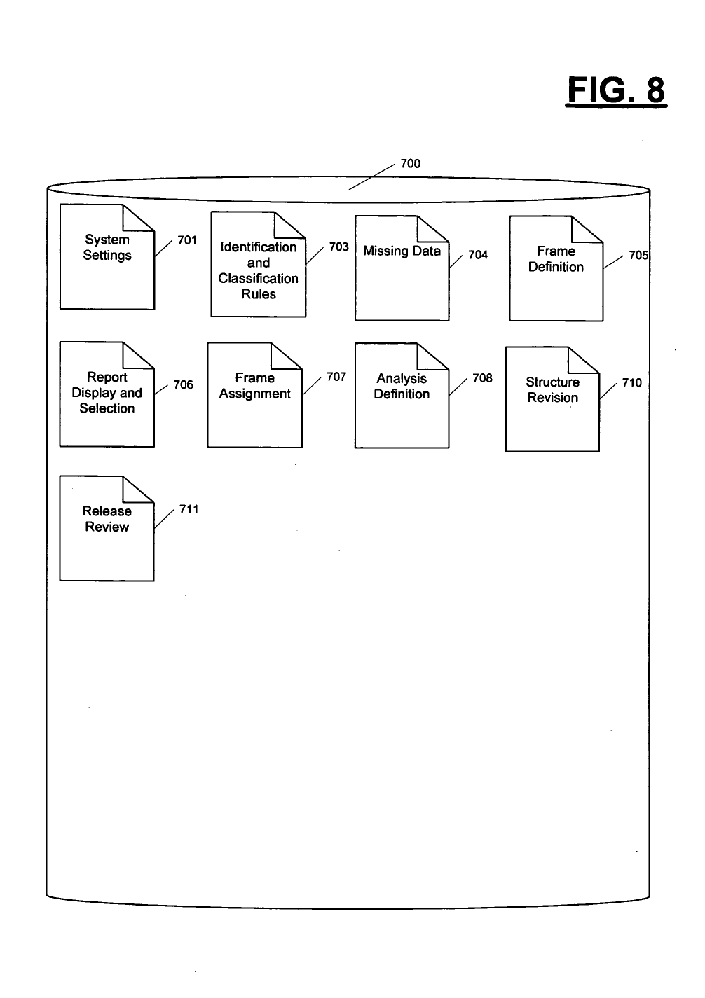

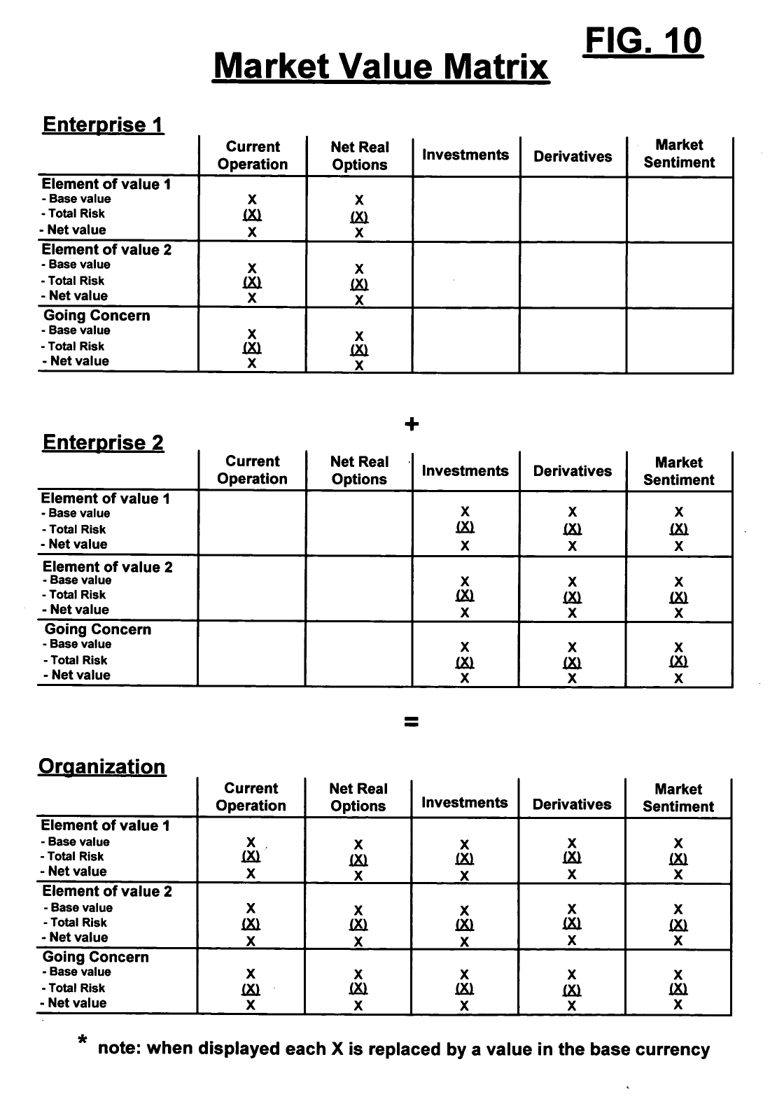

The integration and optimization of the different knowledge bases and systems for the multi-enterprise organization is completed in four distinct stages. As shown in FIG. 4, (block 200 from FIG. 1) the first stage of processing integrates the system of the present invention with the organization narrow systems. This virtual, integration facilitates the identification and/or extraction of data and the return of optimized feature sets to the narrow systems for implementation. As shown in FIG. 5A, FIG. 5B and FIG. 5C, the second stage of processing (block 300 from FIG. 1) prepares data from the narrow systems for analysis. As shown in FIG. 6A, FIG. 6B, FIG. 6C and FIG. 6D the third stage of processing (block 400 from FIG. 1) continually defines the market value matrix that quantifies the impact of the elements of value and risks on the segments of value by enterprise (see FIG. 10), and defines the efficient frontier for organization financial performance. As shown in FIG. 7, the fourth stage of processing (block 500 from FIG. 1) displays the market value matrix and the efficient frontier for the organization and analyzes the impact of changes in structure and/or operation on the financial performance of the multi-enterprise organization. If the operation is continuous, then the processing described above is continuously repeated.

### System Integration

The flow diagram in FIG. 4 details the processing that is completed by the portion of the application software (200) that integrates some combination of data, information and knowledge from other applications. As discussed previously, the system of the present invention is also capable of integrating the narrowly focused systems listed in Tables 1 and 2. Operation of the system (100) is illustrated by describing the integration of the system (100) with the basic financial system, the operation management system, the web site management system, the human resource system, the risk management system, an external database, an advanced financial system, an asset management system, a knowledge base and a supply chain system. Communications are completed between the system of the present invention and the: basic financial system database (5), operation management system database (10), web site management system database (12), human resource information system database (15), risk management system database (17), external database (25), advanced financial system database (30), asset management system database (35), knowledge base (36), supply chain system database (37), partner system (39) and the Internet (40) by: enterprise. A brief overview of the different systems will be presented before reviewing each-step of processing completed by this portion (200) of the application software.

Corporate financial software systems are generally divided into two categories: basic and advanced. Advanced financial systems utilize information from the basic financial systems to perform financial analysis, financial forecasting, financial planning and financial reporting functions. Virtually every commercial enterprise uses some type of basic financial system as they are generally required to use these systems to maintain books and records for income tax purposes. An increasingly large percentage of these basic financial systems are resident in computer systems and intranets. Basic financial systems include general-ledger accounting systems with associated accounts receivable, accounts payable, capital asset, inventory, invoicing, payroll and purchasing subsystems. These systems incorporate worksheets, files, tables and databases. These databases, tables and files contain information about the enterprise operations and its related accounting transactions. As will be detailed below, these databases, tables and files are accessed by the application software of the present invention in order to extract the information used for enterprise measurement, management and optimization. The system is also capable of extracting information from a data warehouse or datamart.

General ledger accounting systems generally store only valid accounting transactions. As is well known, valid accounting transactions consist of a debit component and a credit component where the absolute value of the debit component is equal to the absolute value of the credit component. The debits and the credits are posted to the separate accounts maintained within the accounting system. Every basic accounting system has several different types of accounts. The effect that the posted debits and credits have on the different accounts depends on the account type as shown in Table 7.

TABLE 7

| Account Type: | Debit Impact: | Credit Impact: |
|---|---|---|
| Asset | Increase | Decrease |
| Revenue | Decrease | Increase |
| Expense | Increase | Decrease |
| Liability | Decrease | Increase |
| Equity | Decrease | Increase |

### General ledger accounting systems also require that the asset account balances equal the sum of the liability account balances and equity account balances at all times.

The general ledger system generally maintains summary, dollar only transaction histories and balances for all accounts while the associated subsystems, accounts payable, accounts receivable, inventory, invoicing, payroll and purchasing, maintain more detailed historical transaction data and balances for their respective accounts. It is common practice for each subsystem to maintain the detailed information shown in Table 8 for each transaction.

TABLE 8

| Subsystem | Detailed Information |
|---|---|
| Accounts | Vendor, Item(s), Transaction Date, Amount Owed, Due |
| Payable | Date, Account Number |
| Accounts | Customer, Transaction Date, Product Sold, Quantity, |
| Receivable | Price, Amount Due, Terms, Due Date, Account Number |
| Capital | Asset ID, Asset Type, Date of Purchase, Purchase Price, |
| Assets | Useful Life, Depreciation Schedule, Salvage Value |
| Inventory | Item Number, Transaction Date, Transaction Type, |
| | Transaction Qty, Location, Account Number |
| Invoicing | Customer Name, Transaction Date, Product(s) Sold, |
| | Amount Due, Due Date, Account Number |
| Payroll | Employee Name, Employee Title, Pay Frequency, Pay |
| | Rate, Account Number |
| Purchasing | Vendor, Item(s), Purchase Quantity, Purchase Price(s), |
| | Due Date, Account Number |

As is well known, the output from a general ledger system includes income statements, balance sheets and cash flow statements in well defined formats which assist management in measuring the financial performance of the firm during the prior periods when data input and system processing have been completed.

While basic financial systems are similar between firms, operation management systems vary widely depending on the type of company they are supporting. These systems typically have the ability to not only track historical transactions but to forecast future performance. For manufacturing firms, operation management systems such as Enterprise Resource Planning Systems (ERP), Material Requirement Planning Systems (MRP), Purchasing Systems, Scheduling Systems and Quality Control Systems are used to monitor, coordinate, track and plan the transformation of materials and labor into products. Systems similar to the one described above may also be useful for distributors to use in monitoring the flow of products from a manufacturer.

Operation Management Systems in manufacturing firms may also monitor information relating to the production rates and the performance of individual production workers, production lines, work centers, production teams and pieces of production equipment including the information shown in Table 9.

TABLE 9
Operation Management System - Production Information

| | |
|---|---|
| 1. | ID number (employee id/machine id) |
| 2. | Actual hours - last batch |
| 3. | Standard hours - last batch |
| 4. | Actual hours - year to date |
| 5. | Actual/Standard hours - year to date % |
| 6. | Actual setup time - last batch |
| 7. | Standard setup time - last batch |
| 8. | Actual setup hours - year to date |
| 9. | Actual/Standard setup hrs - yr to date % |
| 10. | Cumulative training time |
| 11. | Job(s) certifications |
| 12. | Actual scrap - last batch |
| 13. | Scrap allowance - last batch |
| 14. | Actual scrap/allowance - year to date |
| 15. | Rework time/unit last batch |
| 16. | Rework time/unit year to date |
| 17. | QC rejection rate - batch |
| 18. | QC rejection rate - year to date |

Operation management systems are also useful for tracking requests for service to repair equipment in the field or in a centralized repair facility. Such systems generally store information similar to that shown below in Table 10.

TABLE 10
Operation Management System - Service Call Information

| | |
|---|---|
| 1. | Customer name |
| 2. | Customer number |
| 3. | Contract number |
| 4. | Service call number |
| 5. | Time call received |
| 6. | Product(s) being fixed |
| 7. | Serial number of equipment |
| 8. | Name of person placing call |
| 9. | Name of person accepting call |
| 10. | Promised response time |
| 11. | Promised type of response |
| 12. | Time person dispatched to call |
| 13. | Name of person handling call |
| 14. | Time of arrival on site |
| 15. | Time of repair completion |
| 16. | Actual response type |
| 17. | Part(s) replaced |
| 18. | Part(s) repaired |
| 19. | 2nd call required |
| 20. | 2nd call number |

Web site management system databases keep a detailed record of every visit to a web site, they can be used to trace the path of each visitor to the web site and upon further analysis can be used to identify patterns that are most likely to result in purchases and those that are most likely to result in abandonment. This information can also be used to identify which promotion would generate the most value for the enterprise using the system. Web site management systems generally contain the information shown in Table 11.

TABLE 11
Web site management system database

| | |
|---|---|
| 1. | Customer's URL |
| 2. | Date and time of visit |
| 3. | Pages visited |
| 4. | Length of page visit (time) |
| 5. | Type of browser used |
| 6. | Referring site |
| 7. | URL of site visited next |
| 8. | Downloaded file volume and type |
| 9. | Cookies |
| 10. | Transactions |

Computer based human resource systems may some times be packaged or bundled within enterprise resource planning systems such as those available from SAP, Oracle and Peoplesoft. Human resource systems are increasingly used for storing and maintaining corporate records concerning active employees in sales, operations and the other functional specialties that exist within a modern corporation. Storing records in a centralized system facilitates timely, accurate reporting of overall manpower statistics to the corporate management groups and the various government agencies that require periodic updates. In some cases, human resource systems include the enterprise payroll system as a subsystem. In one embodiment of the present invention, the payroll system is part of the basic financial system. These systems can also be used for detailed planning regarding future manpower requirements. Human resource systems typically incorporate worksheets, files, tables and databases that contain information about the current and past employees. As will be detailed below, these databases, tables and files are accessed by the application software of the present invention in order to extract the information used in for completing a business valuation. It is common practice for human resource systems to store the information shown in Table 12 for each employee.

TABLE 12
Human Resource System Information

| | |
|---|---|
| 1. | Employee name |
| 2. | Job title |
| 3. | Job code |
| 4. | Rating |
| 5. | Division |
| 6. | Department |
| 7. | Employee No./(Social Security Number) |
| 8. | Year to date - hours paid |
| 9. | Year to date - hours worked |
| 10. | Employee start date - enterprise |
| 11. | Employee start date - department |
| 12. | Employee start date - current job |
| 13. | Training courses completed |
| 14. | Cumulative training expenditures |
| 15. | Salary history |
| 16. | Current salary |
| 17. | Educational background |
| 18. | Current supervisor |

Risk management system databases (17) contain statistical data about the past behavior and forecasts of likely future behavior of interest rates, currency exchange rates, weather, commodity prices and key customers (credit risk systems). They also contain detailed information about the composition and mix of risk reduction products (derivatives, insurance, etc.) the enterprise has purchased. Some companies also use risk management systems to evaluate the desirability of extending or increasing credit lines to customers. The information from these systems is used to supplement the risk information developed by the system of the present invention.

External databases can be used for obtaining information that enables the definition and evaluation of a variety of things including elements of value, external factors, industry real options and event risks. In some cases, information from these databases can be used to supplement information obtained from the other databases and the Internet (5, 10, 12, 15, 17, 30, 35, 36, 37, 39 and 40). In the system of the present invention, the information extracted from external databases (25) includes the data listed in Table 13.

TABLE 13
Types of information

| | |
|---|---|
| 1) | Numeric information such as that found in the SEC Edgar |
| | database and the databases of financial infomediaries such as |
| | FirstCall, IBES and Compustat, |
| 2) | Text information such as that found in the Lexis |
| | Nexis database and databases containing past issues from |
| | specific publications, |
| 3) | Risk management products such as derivatives, swaps |
| | and standardized insurance contracts that can be purchased on line, |
| 4) | Geospatial data; |
| 5) | Multimedia information such as video and audio clips |
| 6) | Event risk data including information about the likelihood |
| | of a loss and the magnitude of such a loss |

The system of the present invention uses different “bot” types to process each distinct data type from external databases (25). The same “bot types” are also used for extracting each of the different types of data from the Internet (40). The system of the present invention must have access to at least one data source (usually, an external database (25)) that provides information regarding the equity prices for each enterprise and the equity prices and financial performance of the competitors for each enterprise.

Advanced financial systems may also use information from external databases (25) and the Internet (40) in completing their processing. Advanced financial systems include financial planning systems and activity based costing systems. Activity based costing systems may be used to supplement or displace the operation of the expense component analysis segment of the present invention. Financial planning systems generally use the same format used by basic financial systems in forecasting income statements, balance sheets and cash flow statements for future periods. Management uses the output from financial planning systems to highlight future financial difficulties with a lead time sufficient to permit effective corrective action and to identify problems in enterprise operations that may be reducing the profitability of the business below desired levels. These systems are most often developed by individuals within companies using two and three-dimensional spreadsheets such as Lotus 1-2-3®, Microsoft Excel® and Quattro Pro®. In some cases, financial planning systems are built within an executive information system (EIS) or decision support system (DSS). For one embodiment of the present invention, the advanced finance system database is similar to the financial planning system database detailed in U.S. Pat. No. 5,165,109 for “Method of and System for Generating Feasible, Profit Maximizing Requisition Sets”, by Jeff S. Eder.

While advanced financial planning systems have been around for some time, asset management systems are a relatively recent development. Their appearance is further proof of the increasing importance of “soft” assets. Asset management systems include: customer relationship management systems, partner relationship management systems, channel management systems, knowledge management systems, visitor relationship management systems, intellectual property management systems, investor management systems, vendor management systems, alliance management systems, process management systems, brand management systems, workforce management systems, human resource management systems, email management systems, IT management systems and/or quality management systems. Asset management systems are similar to operation management systems in that they generally have the ability to forecast future events as well as track historical occurrences. As discussed previously, many of these systems have added analytical capabilities that allow them to identify trends and patterns in the data associated with the asset they are managing. Customer relationship management systems are the most well established asset management systems at this time and will be the focus of the discussion regarding asset management system data. In firms that sell customized products, the, customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 14.

TABLE 14
Customer Relationship Management System - Information

| | |
|---|---|
| 1. | Customer/Potential customer name |
| 2. | Customer number |
| 3. | Address |
| 4. | Phone number |
| 5. | Source of lead |
| 6. | Date of first purchase |
| 7. | Date of last purchase |
| 8. | Last sales call/contact |
| 9. | Sales call history |
| 10. | Sales contact history |
| 11. | Sales history: product/qty/price |
| 12. | Quotations: product/qty/price |
| 13. | Custom product percentage |
| 14. | Payment history |
| 15. | Current A/R balance |
| 16. | Average days to pay |

Supply chain systems could be considered as asset management systems as they are used to manage a critical asset—supplier relationships. However, because of their importance and visibility they are listed separately. Supply chain system databases (37) contain information that may have been in operation management system databases (10) in the past. These systems provide enhanced visibility into the availability of goods and promote improved coordination between customers and their suppliers. All supply chain systems would be expected to track all of the items ordered by the enterprise after the first purchase and store information similar to that shown below in Table 15.

TABLE 15
Supply chain system Information

| | |
|---|---|
| 1. | Stock Keeping Unit (SKU) |
| 2. | Vendor |
| 3. | Total quantity on order |
| 4. | Total quantity in transit |
| 5. | Total quantity on back order |
| 6. | Total quantity in inventory |
| 7. | Quantity available today |
| 8. | Quantity available next 7 days |
| 9. | Quantity available next 30 days |
| 10. | Quantity available next 90 days |
| 11. | Quoted lead time |
| 12. | Actual average lead time |

Project management systems, process management systems and risk management systems can also be integrated with the system of the present invention by mapping their data to the market value matrix in a manner similar to that described for systems focused on the management of one element of value. These systems would in general have data that relates to more than one matrix cell.

System processing of the information from the different databases (5, 10, 12, 15, 17, 25, 30, 35, 36, 37, 39) and the Internet (40) described above starts in a block 201, FIG. 4. The software in block 201 prompts the user (20) via the system settings data window (701) to provide system setting information. The system setting information entered by the user (20) is transmitted via the network (45) back to the application-server (120) where it is stored in the system settings table (140) in the application database (50) in a manner that is well known. The specific inputs the user (20) is asked to provide at this point in processing are shown in Table 16.

TABLE 16

| | |
|---|---|
| 1. | New calculation or structure revision? |
| 2. | Continuous, If yes, new calculation frequency? (by minute, hour, |
| | day, week) |
| 3. | Organization structure (enterprises) |
| 4. | Enterprise structures (segments of value, elements of value, external |
| | factors etc.) |
| 5. | Enterprise industry classifications (SIC Code) |
| 6. | Names of primary competitors by SIC Code |
| 7. | Keywords (brands, etc.) |
| 8. | Baseline account structure |
| 9. | Baseline units of measure |
| 10. | Base currency |
| 11. | Geocoding standard |
| 12. | The maximum number of generations to be processed without |
| | improving fitness |
| 13. | Default clustering algorithm (selected from list) and maximum cluster |
| | number |
| 14. | Number of months a product is considered new after it is first |
| | produced |
| 15. | Default management report types (text, graphic, both) |
| 16. | Default missing data procedure |
| 17. | Maximum time to wait for user input |
| 18. | Risk free interest rate |
| 19. | Maximum number of sub elements |
| 20. | Confidence interval for risk reduction programs |
| 21. | Simulation (aka risk and return analysis) time periods |
| 22. | Dates for history (optional) |
| 23. | Minimum working capital level (optional) |
| 24. | Detailed valuation using components of current operation value? (yes |
| | or no) |
| 25. | Use of industry real options? (yes or no) |
| 26. | Semantic mapping? (yes or no) |
| 27. | Industry portfolio (optional) |
| 28. | Market portfolio (for base market risk calculation) |
| 29. | Most likely scenario - mix of normal and extreme (default is normal) |

The system settings data are used by the software in block 201 to develop a market value matrix for each enterprise in the organization. The market value matrix is defined by the segments of value, elements of value and external factors. The subcategories for each element of value include the element base value, element variability risk, external factor variability risk, event risk, strategic event risk and market risk. The application of the remaining system settings will be further explained as part of the detailed explanation of the system operation. The software in block 201 also uses the current system date to determine the time periods (generally in months) that require data to complete the calculations. In one embodiment the analysis of market value by the system utilizes data from every data source for the four year period before and the three year forecast period after the specified valuation date and/or the date of system calculation. The user (20) also has the option of specifying the data periods that will be used for completing system calculations. After the date range is calculated it is stored in the system settings table (140), processing advances to a software block 210.

In one embodiment the software in block 210 establishes one or more operating system or middleware layers in order to communicate via a network (45) with the different databases (5, 10, 12, 15, 17, 25, 30, 35, 36, 37, 39) that are being integrated within the novel system for integration. Other mechanisms such as integrating the data. While any number of methods can be used to identify the different data sources, in one embodiment the systems are identified using UDDI protocols and the systems include information that identifies the cell or cells within the market value matrix that their stored information pertains to as described previously. The data within each database that is available for extraction is tagged as described previously. The software in block 210 operates continuously to extract and store (virtually or physically) data, information and/or knowledge in accordance with the xml schema or ontology that reflects the market value matrix structure and incorporates the data dictionary. Processing in the system of the present invention continues in a software block 303 that prepares the extracted data for analysis.

After the system processing described below has been completed, the tagged set of optimized features for each narrow system and the entire market value matrix are sent by a software block 511 back to a software block 210. The software in block 210 makes this information continually available to the narrow systems, supplier systems and to partner systems. This information is made available by providing access to a layer, providing access to a The information that is available to narrow systems, partner systems and supplier systems via a network (45) includes:
1. Packets containing optimized sets of feature data and customized ontology data. The optimized feature data will bring the organization closer to the efficient frontier when implemented. The ontology data in the packets are customized in accordance with the location of the narrow system within the market value matrix. More specifically, the narrow systems are provided with information concerning the portions of the market value matrix that are impacted by the portion of the market value matrix they are analyzing/managing. The statistical information developed in later stages of processing detailed below and stored in the matrix data table (143) is used for quantifying the inter-relationships in order to determine what information needs to included in each customized data packet. In addition to information about inter-relationships related to value and risk creation, operational data such as inventory position, order status, etc. is also included (note this could be included in a separate packet or accessed separately from a central location). In this way, each narrow system can make an accurate estimate regarding the likely impact on the enterprise and organization of changes in their features; and
2. Packets containing knowledge from the knowledge bases that have been integrated with the market value matrix structure are also made available. This can include technical knowledge, procedure knowledge and physical characteristics about the organization and its elements, factors, processes, projects and risks.

The software in block 210 also stores requests for information from partner systems such as those disclosed in cross-referenced application Ser. No. 10/012,374, filed Dec. 12, 2001 in the data request table (144) and transmits data transmissions to the financial service providers that have been approved by the user (20).

### Data Preparation

The flow diagrams in FIG. 5A, FIG. 5B and FIG. 5C, detail the processing that is completed by the portion of the application software (300) that prepares data for analysis.

The software in block 303 immediately passes processing to a software block 305. The software in block 305 checks the system settings table (140) and the matrix data table (143) to see if data are missing from any of the periods used for system calculation. The software in block 201 previously calculated and stored a suggested range of dates. If there are no data missing from any specified period—other than derivative values which will be evaluated later—then processing advances to a software block 310. Alternatively, if there are missing data for any field except derivative values for any period, then processing advances to a block 306.

The software in block 306 prompts the user (20) via the missing data window (704) to specify the method to be used for filling the blanks for each field that is missing data. Options the user (20) can choose for filling the blanks include: the average value for the item over the entire time period, the average value for the item over a specified period, zero, the average of the preceding item and the following item values and direct user input for each missing item. If the user (20) does not provide input within a specified interval, then the default missing data procedure specified in the system settings table (140) is used. When all the blanks have been filled and stored for all of the missing data, system processing advances to a block 310.

The software in block 310 prompts the user (20) via the frame definition window (705) to specify frames for analysis. Frames are sub-sets of each enterprise that can be analyzed at the value driver level separately. For example, the user (20) may wish to examine value and/or risk by country, by division, by project, by process, by action, by program or by manager. Frames can also be used for special purposes like collecting budget data. The software in block 310 saves the frame definitions the user (20) specifies in the frame definition table (146) by enterprise in the application database (50) before processing advances to a software block 311.

The software in block 311 assigns one or more frame designations to all element data and factor data that were stored in the matrix data table (143) in the prior stage (200) of processing. After storing the revised element and factor data records in the matrix data table (143), the software in the block retrieves the element, segment and external factor definitions from the system settings table (140) and updates and saves the revised definitions in order to reflect the impact of new frame definitions before processing advances to a software block 312.

The software in block 312 checks the matrix data table (143) to see if there are frame assignments for all element and factor data. If there are frame assignments for all data, then processing advances to a software block 321. Alternatively, if there are data without frame assignments, then processing advances to a software block 313.

The software in block 313 retrieves data from the matrix data table (143) that don't have frame assignments and then prompts the user (20) via the frame assignment window (707) to specify frame assignments for these variables. The software in block 313 saves the frame assignments the user (20) specifies as part of the data record for the variable in the matrix data table (143) by enterprise before processing advances to software block 321.

The software in block 321 checks the system settings table (140) to see if semantic mapping is being used. If semantic mapping is not being used, then processing advances to a block 324. Alternatively, if the software in block 321 determines that semantic mapping is being used, processing advances to a software block 322.

The software in block 322 checks the bot date table (149) and deactivates inference bots with creation dates before the current system date and retrieves information from the system settings table (140) and the classified text table (151). The software in block 322 then initializes inference bots for each keyword (including competitor name) in the system settings table (140) and the classified text table (151) to activate with the frequency specified by user (20) in the system settings table (140).

Bots are independent components of the application that have specific tasks to perform. In the case of inference bots, their task is to use Bayesian inference algorithms to determine the characteristics that give meaning to the text associated with keywords and classified text previously stored in the application database (50). Every inference bot contains the information shown in Table 17.

TABLE 17
1. Unique ID number (based on date, hour, minute, second of creation)
2. Creation date (date, hour, minute, second)
3. Mapping information
4. Storage location
5. Organization
6. Enterprise
7. Keyword
8. Classified text mapping information

After being activated, the inference bots determine the characteristics that give the text meaning in accordance with their programmed instructions with the frequency specified by the user (20) in the system settings table (140). The information defining the characteristics that give the text meaning is stored in the semantic map table (145) and any new keywords identified during the processing are stored in the classified text table (151) in the application database (50) before processing advances to block 324.

The software in block 324 checks the bot date table (149) and deactivates text bots with creation dates before the current system date and retrieves information from the system settings table (140), the classified text table (151) and the semantic map table (145). The software in block 324 then initializes text bots for each keyword stored in the two tables. The bots are programmed to activate with the frequency specified by user (20) in the system settings table (140).

Bots are independent components of the application that have specific tasks to perform. In the case of text bots, their tasks are to locate, count, classify and extract keyword matches from the external database (25) and the asset management system database (35) (note: this includes unstructured text) and then store the results as item variables in the specified location. The classification includes both the enterprise matrix cell (or cells) that the keyword is associated with and the context of the keyword mention in accordance with the semantic map that defines context. This dual classification allows the system of the present invention to identify both the number of times a keyword was mentioned and the context in which the keyword appeared. Every bot initialized by software block 324 will store the extracted location, count, date and classification data it discovers in the classified text table (151) by matrix cell, by enterprise. Every text bot contains the information shown in Table 18.

TABLE 18

| | |
|---|---|
| 1. | Unique ID number (based on date, hour, minute, second of creation) |
| 2. | Creation date (date, hour, minute, second) |
| 3. | Storage location |
| 4. | Mapping information |
| 5. | Organization |
| 6. | Enterprise |
| 7. | Data source |
| 8. | Keyword |
| 9. | Storage location |
| 10. | Semantic map |

After being initialized, the bots locate data from the external database (25) or the asset management system database (35) in accordance with its programmed instructions with the frequency specified by user (20) in the system settings table (140). As each bot locates and extracts text data, processing advances to a software block 325 before the bot completes data storage. The software in block 325 checks to see if all keyword hits are classified by enterprise, matrix cell and semantic map. If the software in block 325 does not find any unclassified “hits”, then the address, count and classified text are stored in the classified text table (151) by enterprise. Alternatively, if there are terms that have not been classified, then processing advances to a block 330. The software in block 330 prompts the user (20) via the identification and classification rules window (703) to provide classification rules for each new term. The information regarding the new classification rules is stored in the semantic map table (145) while the newly classified text is stored in the classified text table (151) by enterprise. It is worth noting at this point that the activation and operation of bots with classified data (50) continues. Only bots with unclassified fields “wait” for user input before completing data storage. The new classification rules will be used the next time bots are initialized in accordance with the frequency established by the user (20). In either event, system processing then passes on to software block 326.

The software in block 326 checks the bot date table (149) and deactivates internet text and linkage bots with creation dates before the current system date and retrieves information from the system settings table (140), the classified text table (151) and the semantic map table (145). The software in block 326 then initializes text bots for each keyword stored in the two tables. The bots are programmed to activate with the frequency specified by user (20) in the system settings table (140).

Bots are independent components of the application that have specific tasks to perform. In the case of internet text and linkage bots, their tasks are to locate, count, classify and extract keyword matches and linkages from the Internet (40) and then store the results as item variables in a specified location. The classification includes the enterprise matrix cell (or cells) that the keyword is associated with, the context of the keyword mention in accordance with the semantic map that defines context and the links associated with the keyword. Every bot initialized by software block 326 will store the extracted location, count, date, classification and linkage data it discovers in the classified text table (151) by matrix cell, by enterprise. Multimedia data can be processed using these same bots if software to translate and parse the multimedia content is included in each bot. Every Internet text and linkage bot contains the information shown in Table 19.

TABLE 19
1. Unique ID number (based on date, hour, minute, second of creation)
2. Creation date (date, hour, minute, second)
3. Storage location
4. Mapping information
5. Home URL
6. Organization
7. Enterprise
8. Keyword
9. Semantic map

After being initialized, the text and linkage bots locate and classify data from the Internet (40) in accordance with their programmed instructions with the frequency specified by user (20) in the system settings table (140). As each bot locates and classifies data from the Internet (40) processing advances to a software block 325 before the bot completes data storage. The software in block 325 checks to see if all linkages and keyword hits have been classified by enterprise, matrix cell and semantic map. If the software in block 325 does not find any unclassified “hits” or “links”, then the address, counts, dates, linkages and classified text are stored in the classified text table (151) by enterprise. Alternatively, if there are hits or links that haven't been classified, then processing advances to a block 330. The software in block 330 prompts the user (20) via the identification and classification rules window (703) to provide classification rules for each new hit or link. The information regarding the new classification rules is stored in the semantic map table (145) while the newly classified text and linkages are stored in the classified text table (151) by enterprise. It is worth noting at this point that the activation and operation of bots where all fields map to the application database (50) continues. Only bots with unclassified fields will “wait” for user input before completing data storage. The new classification rules will be used the next time bots are initialized in accordance with the frequency established by the user (20). In either event, system processing then passes on to a software block 351.

The software in block 351 checks the matrix data table (143) in the application database (50) to see if there are historical values for all the derivatives stored in the table. Because SFAS 133 is still not fully implemented, some companies may not have data regarding the value of their derivatives during a time period where data are used. If there are values stored for all time periods, then processing advances to a software block 355. Alternatively, if there are periods when the value of one or more derivatives has not been stored, then processing advances to a software block 352. The software in block 352 retrieves data from the matrix data table (143) in order to value each derivative using a risk neutral valuation method for the time period or time periods that are missing values. The algorithms used for this analysis can include Quasi Monte Carlo or equivalent Martingale. Other algorithms can be used to the same effect. When the calculations are completed, the resulting values are stored in the matrix data table (143) by enterprise and processing advances to software block 355.

The software in block 355 calculates pre-defined attributes by item for each numeric item variable in the matrix data table (143) and the, classified text table (151). The attributes calculated in this step include: summary data like cumulative total value; ratios like the period to period rate of change in value; trends like the rolling average value, comparisons to a baseline value like change from a prior years level and time lagged values like the time lagged value of each numeric item variable. The software in block 355 calculates similar attributes for the text and geospatial item variables stored in the matrix data table (143). The software in block 355 also calculates attributes for each item date variable in the matrix data table (143) and the classified text table (151) including summary data like time since last occurrence and cumulative time since first occurrence; and trends like average frequency of occurrence and the rolling average frequency of occurrence. The numbers derived from the item variables are collectively referred to as “item performance indicators”. The software in block 355 also calculates pre-specified combinations of variables called composite variables for measuring the strength of the different elements of value. The item performance indicators and the composite variables are tagged and stored in the matrix data table (143) or the classified text table (151) by enterprise before processing advances to a block 356.

The software in block 356 uses attribute derivation algorithms such as the AQ program to create combinations of the variables that were not pre-specified for combination. While the AQ program is used in one embodiment of the present, invention, other attribute derivation algorithms, such as the LINUS algorithms, may be used to the same effect. The software creates these attributes using both item variables that were specified as “element” variables and item variables that were not. The resulting composite variables are tagged and stored in the matrix data table (143) before processing advances to a block 357.

The software in block 357 derives external factor indicators for each factor numeric data field stored in the matrix data table (143). For example, external factors include: the ratio of enterprise earnings to expected earnings, the number and amount of jury awards, commodity prices, the inflation rate, growth in gross domestic product, enterprise earnings volatility vs. industry average volatility, short and long term interest rates, increases in interest rates, insider trading direction and levels, industry concentration, consumer confidence and the unemployment rate that have an impact on the market price of the equity for an enterprise and/or an industry. The external factor indicators derived in this step include: summary data like cumulative totals, ratios like the period to period rate of change, trends like the rolling average value, comparisons to a baseline value like change from a prior years price and time lagged data like time lagged earnings forecasts. In a similar fashion the software in block 357 calculates external factors for each factor date field in the matrix data table (143) including summary factors like time since last occurrence and cumulative time since first occurrence; and trends like average frequency of occurrence and the rolling average frequency of occurrence. The numbers derived from numeric and date fields are collectively referred to as “factor performance indicators”. The software in block 357 also calculates pre-specified combinations of variables called composite factors for measuring the strength of the different external factors. The external factors, factor performance indicators and the composite factors are tagged and stored in the matrix data table (143) by matrix cell before processing advances to a block 360.

The software in block 360 uses attribute derivation algorithms, such as the Linus algorithm, to create combinations of the external factors that were not pre-specified for combination. While the Linus algorithm is used in one embodiment of the present invention, other attribute derivation algorithms, such as the AQ program, may be used to the same effect. The software creates these attributes using both external factors that were included in “composite factors” and external factors that were not. The resulting composite variables are tagged and stored in the matrix data table (143) by matrix cell before processing advances to a block 361.

The software in block 361 uses pattern-matching algorithms to classify, data fields for elements of value and external factors to pre-defined groups with numerical values. This type of analysis is useful in classifying transaction patterns as “heavy”, “light”, “moderate” or “sporadic”. This analysis can be used to classify web site activity, purchasing patterns and advertising frequency among other things. The numeric values associated with the classifications are item performance indicators. They are tagged and stored in the matrix data table (143) by matrix cell before processing advances to a block 362.

The software in block 362 retrieves data from the system settings table (140) and the matrix data table (143) in order to calculate the historical risk and return for the market portfolio identified by the user (20) in the system settings table. After the calculation is completed, the resulting value is saved in the benchmark return table (147) in the application database (50). When data storage is complete, processing advances to a software block 402.

### Analysis

The flow diagrams in FIG. 6A, FIG. 6B, FIG. 6C and FIG. 6D detail the processing that is completed by the portion of the application software (400) that continually generates the market value matrix (see FIG. 10) by creating and activating analysis bots that:
1. Identify the factor variables, factor performance indicators and composite factors for each external factor that drive: three of the segments of value—current operation, derivatives and investments—as well as the components of current operation value (revenue, expense and changes in capital);
2. Identify the item variables, item performance indicators and composite variables for each element and sub-element of value that drive: three segments of value—current operation, derivatives and financial assets—as well as the components of current operation value (revenue, expense and changes in capital);
3. Create vectors that summarize the impact of the factor variables, factor performance indicators and composite factors for each external factor;
4. Create vectors, that summarize the performance of the item variables, item performance indicators and composite variables for each element of value and sub-element of value in driving segment value;
5. Determine the expected life of each element of value and sub-element of value;
6. Determine the current operation value, real option value, investment value and derivative value, as well as revenue component value, expense component value and capital component value of said current operations using the information prepared in the previous stages of processing;
7. Specify and optimize causal predictive models to determine the relationship between the vectors generated in steps 3 and 4 and three of the segments of value, current operation, derivatives and investments, as well as the three components of current operation value (revenue, expense and changes in capital);
8. Identify likely scenarios for the evolution of value drivers and event risks;
9. Quantify all risks under a variety of scenarios for each enterprise;
10. Determine the best causal indicator for enterprise stock price movement, calculate market sentiment under the most likely scenario and analyze the causes of market sentiment; and
11. Combine the results of all prior stages of processing to determine the value of each cell and cell subcategory within the market value matrix.

Each analysis bot generally normalizes -the data being analyzed before processing begins. As discussed previously, processing one embodiment includes an analysis of all five segments of value for the organization, it is to be understood that the system of the present invention can complete calculations for any combination of the five segments. For example, when a company is privately held it does not have a market price and as a result the market sentiment segment of value is hot analyzed.

Processing in this portion of the application begins in software block 402. The software in block 402 checks the system settings table (140) in the application database (50) to determine if the current calculation is a new calculation or a structure change. If the calculation is not a new calculation or a structure change, then processing advances to a software block 418. Alternatively, if the calculation is new or a structure change, then processing advances to a software block 403.

The software in block 403 retrieves data from the system settings table (140) and the matrix data table (143) and then assigns unassigned item variables, item performance indicators and composite variables to each element of value identified in the system settings table (140) using a three-step process. First, unassigned item variables, item performance indicators and composite variables are assigned to elements of value based on the asset management system they correspond to (for example, all item variables from a brand management system and all item performance indicators and composite variables derived from brand management system item variables are assigned to the brand element of value). Second, pre-defined composite variables are assigned to the element of value they were assigned to measure in the system settings table (140). Finally, item variables, item performance indicators and composite variables identified by the text and geospatial bots are assigned to elements on the basis of their element classifications. If any item variables, item performance indicators or composite variables are un-assigned at this point they are assigned to a going concern element of value. After the assignment of variables and indicators to elements is complete, the resulting assignments are saved to the matrix data table (143) by enterprise and processing advances to a block 404.

The software in block 404 retrieves data from the system, settings table (140), the matrix data table (143) and the frame definition table (146) and then assigns unassigned factor variables, factor performance indicators and composite factors to each external factor. Factor variables, factor performance indicators and composite factors identified by the text bots are then assigned to factors on the basis of their factor classifications. The resulting assignments are saved to the matrix data table (143) by enterprise and processing advances to a block 405.

The software in block 405 checks the system settings table (140) in the application database (50) to determine if any of the enterprises in the organization being analyzed have market sentiment segments. If there are market sentiment segments for any enterprise, then processing advances to a block 406. Alternatively, if there are no market prices for equity for any enterprise, then processing advances to a software block 408.

The software in block 406 checks the bot date table (149) and deactivates market value indicator bots with creation dates before the current system date. The software in block 406 then initializes market value indicator bots in accordance with the frequency specified by the user (20) in the system settings table (140). The bot retrieves the information from the system settings table (140) and the matrix data table (143) before saving the resulting information in the application database (50).

Bots are independent components of the application, that have specific tasks to perform. In the case of market value indicator bots their primary task is to identify the best market value indicator (price, relative price, yield, option price, first derivative of price change or second derivative of price change) for the time period being examined. The market value indicator bots select the best value indicator by grouping the S&P 500 using each of the five value indicators with a Kohonen neural network. The resulting clusters are then compared to the known groupings of the S&P 500. The market value indicator that produced the clusters that most closely match the S&P 500 groupings is selected as the market value indicator. Every market value indicator bot contains the information shown in Table 20.

TABLE 20
1. Unique ID number (based on date, hour, minute, second of creation)
2. Creation date (date, hour, minute, second)
3. Mapping information
4. Storage location
5. Organization
6. Enterprise

### When bots in block 406 have identified and stored the best market value indicator in the matrix data table (143), processing advances to a block 407.

The software in block 407 checks the bot date table (149) and deactivates temporal clustering bots with creation dates before the current system date. The software in block 407 then initializes a bot in accordance with the frequency specified by the user (20) in the system settings table (140). The bot retrieves information from the system settings table (140) and the matrix data table (143) in order and define regimes for the enterprise market value before saving the resulting cluster information in the application database (50).

Bots are independent components of the application that have specific tasks to perform. In the case of temporal clustering bots, their primary task is to segment the market price data by enterprise using the market value indicator selected by the bot in block 406 into distinct time regimes that share similar characteristics. The temporal clustering bot assigns a unique identification (id) number to each “regime” it identifies before tagging and storing the unique id numbers in the matrix data table (143). Every time period with data are assigned to one of the regimes. The cluster id for each regime is saved in the data record for each piece of element data and factor data in the matrix data table (143) by enterprise. If there are enterprises in the organization that don't have market sentiment calculations, then the time regimes from the primary enterprise specified by the user in the system settings table (140) are used in labeling the data for the other enterprises. The time periods are segmented for each enterprise with a market value using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 21.

TABLE 21
1. Unique ID number (based on date, hour, minute, second of creation)
2. Creation date (date, hour, minute, second)
3. Mapping information
4. Storage location
5. Maximum number of clusters
6. Organization
7. Enterprise

### When bots in block 407 have identified and stored regime assignments for all time periods with data by enterprise, processing advances to a software block 408.

The software in block 408 checks the bot date table (149) and deactivates variable clustering bots with creation dates before the current system date. The software in block 408 then initializes bots in order for each element of value and external factor by enterprise. The bots activate in accordance with the frequency, specified by the user (20) in the system settings table (140), retrieve the information from the system settings table (140) and the matrix data table (143) and define segments for the element data and factor data before tagging and saving the resulting cluster information in the matrix data table (143).

Bots are independent components of the application that have specific tasks to perform. In the case of variable clustering bots, their primary task is to segment the element data and factor data into distinct clusters that share similar characteristics. The clustering bot assigns a unique id number to each “cluster” it identifies, tags and stores the unique id numbers in the matrix data table (143). Every, item variable for every element of value is assigned to one of the unique clusters. The cluster id for each variable is saved in the data record for each variable in the table where it resides. In a similar fashion, every factor variable for every external factor is assigned to a unique cluster. The cluster id for each variable is tagged and saved in the data record for the factor variable. The element data and factor data are segmented into a number of clusters less than or equal to the maximum specified by the user (20) in the system settings table (140). The data are segmented using the “default” clustering algorithm the user (20) specified in the system settings table (140). The system of the present invention provides the user (20) with the choice of several clustering algorithms including: an unsupervised “Kohonen” neural network, neural network, decision tree, support vector method, K-nearest neighbor, expectation maximization (EM) and the segmental K-means algorithm. For algorithms that normally require the number of clusters to be specified, the bot will iterate the number of clusters until it finds the cleanest segmentation for the data. Every variable clustering bot contains the information shown in Table 22.

TABLE 22

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Element of value, sub element of value or external factor |
| 6. | Clustering algorithm type |
| 7. | Organization |
| 8. | Enterprise |
| 9. | Maximum number of clusters |
| 10. | Variable 1 |
| . . . to | |
| 10 + n. | Variable n |

### When bots in block 408 have identified, tagged and stored cluster assignments for the data associated with each element of value, sub-element of value or external factor in the matrix data table (143), processing advances to a software block 409.

The software in block 409 checks the bot date table (149) and deactivates predictive model bots with creation dates before the current system date. The software in block 409 then retrieves the information from the system settings table (140) and the matrix data table (143) as part of the process of initializing predictive model bots for each component of value.

Bots are independent components of the application that have specific tasks to perform. In the case of predictive model bots, their primary task is to determine the relationship between the element and factor data and the derivative segment of value, the investment segment of value and the current operation segment of value by enterprise. The predictive model bots also determine the relationship between the element data and factor data and the components of current operation value and sub-components of current operation value by enterprise. Predictive model bots are initialized for each component of value, sub-component of value, derivative segment and investment segment by enterprise. They are also initialized for each cluster and regime of data in accordance with the cluster and regime assignments specified by the bots in blocks 407 and 408 by enterprise. A series of predictive model bots is initialized at this stage because it is impossible to know in advance,which predictive model type will produce the “best” predictive model for the data from each commercial enterprise. The series for each model includes 12 predictive model bot types: neural network; CART; GARCH, projection pursuit regression; generalized additive model (GAM), redundant regression network; rough-set analysis, boosted Naive Bayes Regression; MARS; linear regression; support vector method and stepwise regression. Additional predictive model types can be used to the same effect. The software in block 409 generates this series of predictive model bots for the enterprise as shown in Table 23.

TABLE 23
PREDICTIVE MODELS BY ENTERPRISE LEVEL

Enterprise:
Variables* relationship to enterprise cash flow (revenue − expense +
capital change)
Variables* relationship to enterprise revenue component of value
Variables* relationship to enterprise expense subcomponents of value
Variables* relationship to enterprise capital change subcomponents of
value
Variables* relationship to derivative segment of value
Variables* relationship to investment segment of value
Element of Value:
Sub-element of value variables relationship to element of value
*Variables = element and factor data.

Every predictive model bot contains the information shown in Table 24.

TABLE 24

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Enterprise |
| 7. | Global or Cluster (ID) and/or Regime (ID) |
| 8. | Segment (derivative, investment or current operation) |
| 9. | Element, sub-element or external factor |
| 10. | Predictive model type |

After predictive model bots are initialized, the bots activate in accordance with the frequency specified by the user (20) in the system settings table (140). Once activated, the bots retrieve data from the appropriate table in the application database (50) and randomly partition the element or factor data into a training set and a test set. The software in block 409 uses “bootstrapping” where the different training data sets are created by re-sampling with replacement from the original training set so data records may occur more than once. After the predictive model bots complete their training and testing, processing advances to a block 410.

The software in block 410 determines if clustering improved the accuracy of the predictive models generated by the bots in software block 409 by enterprise. The software in block 410 uses a variable selection algorithm such as stepwise regression (other types of variable selection algorithms can be used) to combine the results from the predictive model bot analyses for each type of analysis—with and without clustering—to determine the best set of variables for each type of analysis. The type of analysis having the smallest amount of error as measured by applying the mean squared error algorithm to the test data are given preference in determining the best set of variables for use in later analysis. There are four possible outcomes from this analysis as shown in Table 25.

TABLE 25

1. Best model has no clustering
2. Best model has temporal clustering, no variable clustering
3. Best model has variable clustering, no temporal clustering
4. Best model has temporal clustering and variable clustering

If the software in block 410 determines that clustering improves the accuracy of the predictive models for an enterprise, then processing advances to a software block 413. Alternatively, if clustering does not improve the overall accuracy of the predictive models for an enterprise, then processing advances to a software block 411.

The software in block 411 uses a variable selection algorithm such as stepwise regression (other types of variable, selection algorithms can be used) to combine the results from the predictive model bot analyses for each model to determine the best set of variables for each model. The models having the smallest amount of error, as measured by applying the mean squared error algorithm to the test data, are given preference in determining the best set of variables. As a result of this processing, the best set of variables contain the: item variables, factor variables, item performance indicators, factor performance indications, composite variables and composite factors (aka element data and factor data) that correlate most strongly with changes in the three segments being analyzed and the three components of value. The best set of variables will hereinafter be referred to as the “value drivers”.

Eliminating low correlation factors from the initial configuration of the vector creation algorithms increases the efficiency of the next stage of system processing. Other error algorithms alone or in combination may be substituted for the mean squared error algorithm. After the best set of variables have been selected, tagged and stored in the matrix data table (143) for all models at all levels for each enterprise in the organization, the software in block 411 tests the independence of the value drivers at the enterprise, external factor, element and sub-element level before processing advances to a block 412.

The software in block 412 checks the bot date table (149) and deactivates causal predictive model bots with creation dates before the current system date. The software in block 412 then retrieves the information from the system settings table (140) and the matrix data table (143) as part of the process of initializing causal predictive model bots for each element of value, sub-element of value and external factor in accordance with the frequency specified by the user (20) in the system settings table (140).

Bots are independent components of the application that have specific tasks to perform. In the case of causal predictive model bots, their primary task is to refine the value driver selection to reflect only causal variables. (Note: these variables are summed together to value an element when they are interdependent). A series of causal predictive model bots are initialized at this stage because it is impossible to know in advance which causal predictive model will produce the “best” vector for the best fit variables from each model. The series for each model includes five causal predictive model bot types: Tetrad, MML, LaGrange, Bayesian and path analysis. The software in block 412 generates this series of causal predictive model bots for each set of value drivers stored in the matrix data table (143) in the previous stage in processing. Every causal predictive model bot activated in this block contains the information shown in Table 26.

```
TABLE 26
  1. Unique ID number (based on date, hour, minute, second of creation)
  2. Creation date (date, hour, minute, second)
  3. Mapping information
  4. Storage location
  5. Component or subcomponent of value
  6. Element, sub-element or external factor
  7. Variable set
  8. Causal predictive model type
  9. Organization
10. Enterprise
```

After the causal predictive model bots are initialized by the software in block 412, the bots activate in accordance with the frequency specified by the user (20) in the system settings table (140). Once activated, they retrieve information for each model and sub-divide the variables into two sets, one for training and one for testing. After the causal predictive model bots complete their processing for each model, the software in block 412 uses a model selection algorithm to identify the model that best fits the data for each element of value, sub-element of value and external factor being analyzed. For the system of the present invention, a cross validation algorithm is used for model selection. The software in block 412 tags and saves the best fit causal factors in the vector table (153) by enterprise in the application database (50) and processing advances to a block 418.

The software in block 418 tests the value drivers to see if there is interaction between elements, between elements and external factors or between external factors by enterprise. The software in this block identifies interaction by evaluating a chosen model based on stochastic-driven pairs of value-driver subsets. If the accuracy of such a model is higher that the accuracy of statistically combined models trained on attribute subsets, then the attributes from subsets are considered to be interacting and then they form an interacting set. If the software in block 418 does not detect any: value driver interaction or missing variables for each enterprise, then system processing advances to a block 423. Alternatively, if missing data or value driver interactions across,elements are detected by the software in block 418 for one or more enterprise, then processing advances to a software block 421.

If software in block 410 determines that clustering improves predictive model accuracy, then processing advances to block 413 as described previously. The software in block 413 uses a variable selection algorithm such as stepwise regression (other types of variable selection algorithms can be used) to combine the results from the predictive model bot analyses for each model, cluster and/or regime to determine the best set of variables for each model. The models having the smallest amount of error as measured by applying the mean squared error algorithm to the test data are given preference in determining the best set of variables. As a result of this processing, the best set of variables contains: the element data and factor data that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected, tagged as value drivers and stored in the matrix data table (143) for all models at all levels by enterprise, the software in block 413 tests the independence of the value drivers at the enterprise, element, sub-element and external factor level before processing advances to a block 414.

The software in block 414 checks the bot date table (149) and deactivates causal predictive model bots with creation dates before the current system date. The software in block 414 then retrieves the information from the system settings table (140) and the matrix data table (143) as part of the process of initializing causal predictive model bots for each element of value, sub-element of value and external factor at every level in accordance with the frequency specified by the user (20) in the system settings table (140).

Bots are independent components of the application that have specific tasks to perform. In the case of causal predictive model bots, their primary task is to refine the element and factor value driver selection to reflect only causal variables. (Note: these variables are grouped together to represent a single element vector when they are dependent). In some cases it may be possible to skip the correlation step before selecting causal the item variables, factor variables, item performance indicators, factor performance indicators, composite variables and composite factors (aka element data and factor data). A series of causal predictive model bots are initialized at this stage because it is impossible to know in advance which causal predictive model will produce the “best” vector for the best fit variables from each model. The series for each model includes four causal predictive model bot types: Tetrad, LaGrange, Bayesian and path analysis. The software in block 414 generates this series of causal predictive model bots for each set of value drivers stored in the matrix data table (143) in the previous stage in processing. Every causal predictive model bot activated in this block contains the information shown in Table 27.

```
TABLE 27
  1. Unique ID number (based on date, hour, minute, second of creation)
  2. Creation date (date, hour, minute, second)
  3. Mapping information
  4. Storage location
  5. Component or subcomponent of value
  6. Cluster (ID) and/or Regime (ID)
  7. Element, sub-element or external factor
  8. Variable set
  9. Organization
10. Enterprise
11. Causal predictive model type
```

After the causal predictive model bots are initialized by the software in block 414, the bots activate in accordance with the frequency specified by the user (20) in the system settings table (140). Once activated, they retrieve information, for each model and sub-divide the variables into two sets, one for training and one for testing. The same set of training data are used by each of the different types of bots for each model. After the causal predictive model bots complete their processing for each model, the software in block 414 uses a model selection algorithm to identify the model that best fits the data for each element, sub-element or external factor being analyzed by model and/or regime by enterprise. For the system of the present invention, a cross validation algorithm is used for model selection. The software in block 414 tags and saves the best fit causal factors in the vector table (153) by enterprise in the application database (50) and processing advances to block 418. The software in block 418 tests the value drivers to see if there are “missing” value drivers that are influencing the results as well as testing to see if there are interactions (dependencies) across elements and/or external factors. If the software in block 418 does not detect any missing data or value driver interactions across elements or factors, then system processing advances to a block 423. Alternatively, if missing data or value driver interactions across elements or factors are detected by the software in block 418, then processing advances to a software block 421.

The software in block 421 prompts the user (20) via the structure revision window (710) to adjust the specification(s) for the elements of value, sub-elements of value or external factors in order to minimize or eliminate the interaction that was identified. At this point the user (20) has the option of specifying that one or more elements of value, sub elements of value and/or external factors be combined for analysis purposes (element combinations and/or factor combinations) for each enterprise where there is interaction between elements and/or factors. The user (20) also has the option of specifying that the elements or external factors that are interacting, will be valued by summing the impact of their individual value drivers. Finally, the user (20) can choose to re-assign a value driver to a new element of value or external factor to eliminate the inter-dependency. This process is the preferred solution when the inter-dependent value driver is included in the going concern element of value. Elements and external factors that will be valued by summing their value drivers will not have vectors generated.

Elements of value and external factors do not share value drivers and they are not combined with one another. However, when an external factor and an element of value are shown to be inter-dependent, it is usually because the element of value is a dependent on the external factor. For example, the value of a process typically varies with the price of commodities consumed in the process. In that case, the value of both the external factor and the element of value would be expected to be a function of the same value driver. The software in block 421 examines all the factor-element combinations and suggest the appropriate percentage of factor risk assignment to the different elements it interacts with. For example, 30% of a commodity factor risk could be distributed to each of the 3 processes that consume the commodity with the remaining 10% staying in the going concern element of value. The user (20) either accepts the suggested distribution or specifies his own distribution for each factor-element interaction.

After the input from the user (20) is saved in the system settings table (140) and the matrix data table (143) system processing advances to a software block 423. The software in block 423 checks the system settings table (140) and the matrix data table (143) to see if there any changes in structure. If there have been changes in the structure, then processing advances to block 303 and the system processing described previously is repeated. Alternatively, if there are no changes in structure, then processing advances to a block 425.

The software in block 425 checks the system settings table (140) in the application database (50) to determine if the current calculation is a new one. If the calculation is new, then processing advances to a software block 426. Alternatively, if the calculation is not a new calculation, then processing advances to a software block 433.

The software in block 426 checks the bot date table (149) and deactivates industry rank bots with creation dates before the current system date. The software in block 426 then retrieves the information from the system settings table (140) and the industry ranking table (154) as part of the process of initializing industry rank bots for the enterprise and for the industry in accordance with the frequency specified by the user (20) in the system settings table (140).

Bots are independent components of the application that have specific tasks to perform. In the case of industry rank bots, their primary task is to determine the relative position of each enterprise being evaluated on element data identified in the previous processing step. (Note: these variables are grouped together when they are interdependent). The industry rank bots use ranking algorithms such as Data Envelopment Analysis (hereinafter, DEA) to determine the relative industry ranking of the enterprise being examined. The software in block 426 generates industry rank bots for each enterprise being evaluated. Every industry rank bot activated in this block contains the information shown in Table 28.

TABLE 28
1. Unique ID number (based on date, hour, minute, second of creation)
2. Creation date (date, hour, minute, second)
3. Mapping information
4. Storage location
5. Ranking algorithm
6. Organization
7. Enterprise

After the industry rank bots are initialized by the software in block 426, the bots activate in accordance with the frequency specified by the user (20) in the system settings table (140). Once activated, they retrieve the item variables, item performance indicators, and composite variables from the application database (50) and sub-divides them into two sets, one for training and one for testing. After the industry rank bots develop and test their rankings, the software in block 426 saves the industry rankings in the industry ranking table (154) by enterprise in the application database (50) and processing advances to a block 427. The industry rankings are item variables.

The software in block 427 checks the bot date table (149) and deactivates vector generation bots with creation dates before the current system date. The software in block 427 then initializes bots for each element of value, sub-element of value, element combination, factor combination and external factor for teach enterprise in the organization. The bots activate in accordance with the frequency specified by the user (20) in the system settings table (140), retrieve the information from the system settings table (140) and the matrix data table (143) as part of the process of initializing vector generation bots for each element of value and sub-element of, value in accordance with the frequency specified by the user (20) in the system settings table (140). Bots are independent components of the application that have specific tasks to perform. In the case of vector generation bots, their primary task is to produce formulas, (hereinafter, vectors) that summarize the relationship between the causal value drivers and changes in the component or sub-component of value being examined for each enterprise. The causal value drivers may be grouped by element of value, sub-element of value, external factor, factor combination or element combination. As discussed previously, the vector generation step is skipped for value drivers where the user has specified that value driver impacts will be mathematically summed to determine the value of the element or factor. The vector generation bots use induction algorithms to generate the vectors. Other vector generation algorithms can be used to the same effect. The software in block 427 generates a vector generation bot for each set of causal value drivers stored in the matrix data table (143). Every vector generation bot contains the information shown in Table 29.

TABLE 29
1. Unique ID number (based on date, hour, minute, second of creation)
2. Creation date (date, hour, minute, second)
3. Mapping information
4. Storage location
5. Organization
6. Enterprise
7. Element, sub-element, element combination, factor or factor
combination
8. Segment, component or sub-component of value
9. Factor 1
. . . to
9 + n. Factor n

When bots in block 427 have identified, tagged and stored vectors for all time periods with data for all the elements, sub-elements, element combinations, factor combinations or external factors where vectors are being calculated in the matrix data table (143) and the vector table (153) by enterprise, processing advances to a software block 429.

The software in block 429 checks the bot date table (149) and deactivates financial factor bots with creation dates before the current system date. The software in block 429 then retrieves the information from the system settings table (140) and the matrix data table (143) as part of the process of initializing financial factor bots for the enterprise and the relevant industry in accordance with the frequency specified by the user (20) in the system settings table (140).

Bots are independent components of the application that have specific tasks to perform. In the case of financial factor bots, their primary task is to identify elements of value, external factors and value drivers that are causal factors for changes in the value of: derivatives, investments, enterprise equity and industry equity. The causal factors for enterprise equity and industry equity are those that drive changes in the value indicator identified by the value indicator bots. The series for each model includes two causal predictive model bot types: Tetrad and path analysis. Other causal predictive models can be used to the same effect. The software in block 429 generates this series of causal predictive model bots for each set of causal value drivers stored in the matrix data table (143) in the previous stage in processing by enterprise. Every financial factor bot activated in this block contains the information shown in Table 30.

```
TABLE 30
  1. Unique ID number (based on date, hour, minute, second of creation)
  2. Creation date (date, hour, minute, second)
  3. Mapping information
  4. Storage location
  5. Element, value driver or external factor
  6. Organization
  7. Enterprise
  8. Type: derivatives, investment, organization, enterprise or industry
  equity
  9. Value indicator (price, relative price, first derivative, etc.)
10. Causal predictive model type
```

After the software in block 429 initializes the financial factor, bots, the bots activate in accordance with the frequency specified by the user (20) in the system settings table (140). Once activated, they retrieve information and sub-divide the data into two sets, one for training and one for testing. The same set of training data are used by each of the different types of bots for each model. After the financial factor bots complete their processing for each segment of value, enterprise and industry, the software in block 429 uses a model selection algorithm to identify the model that best fits the data for each. For the system of the present invention, a cross validation algorithm is used for model selection. The software in block 429 tags and saves the best fit causal value drivers in the matrix data table (143) by enterprise and processing advances to a block 430. The software in block 430 tests to see if there are “missing” causal factors, elements or value drivers that are influencing the results by enterprise. If the software in block 430 does not detect any missing factors, elements or value drivers, then system processing advances to a block 431. Alternatively, if missing factors, elements or value drivers are detected by the software in block 430, then processing returns to software block 421 and the processing described in the preceding section is repeated.

The software in block 431 checks the bot date table (149) and deactivates option bots with creation dates before the current system, date. The software in block 431 then retrieves the information from the system settings table (140), the matrix data table (143), the vector table (153) and the industry ranking table (154) as part of the process of initializing option bots for the enterprise.

Bots are independent components of the application that have specific tasks to perform. In the case of option bots, their primary tasks are to value the base value of the real options and contingent liabilities for the enterprise. If the user (20) has chosen to include industry options, then option bots will be initialized for industry options as well. The discount rate for enterprise real options, contingent liabilities and industry options is calculated using a total cost of capital approach that includes the cost of risk capital in a manner that is well known. After the appropriate discount rate is determined, the value of each real option and contingent liability is calculated using the specified algorithms in a manner that is well known. The real option can be valued using a number of algorithms including Black Scholes, binomial, neural network or dynamic programming algorithms. Every option bot contains the information shown in Table 31.

TABLE 31
1. Unique ID number (based on date, hour, minute, second of creation)
2. Creation date (date, hour, minute, second)
3. Mapping information
4. Storage location
5. Organization
6. Industry or Enterprise
7. Real option type (industry or enterprise)
8. Real option algorithm (Black Scholes, quadranomial, dynamic
program, etc.)

After the option bots are initialized, they activate in accordance with the frequency specified by the user (20) in the system settings table (140). After being activated, the bots retrieve information in order to complete the option valuations. When they are used, industry option bots go on to allocate a percentage of the calculated value of industry options to the enterprise on the basis of causal element strength. After the value of the real option, contingent liability or allocated industry option is calculated the resulting values are tagged then saved in the matrix data table (143) in the application database (50) by enterprise before processing advances to a block 432. Alternative methods of achieving the same results using the information in the matrix data table (143) and the industry ranking table (154) would include calculating an discount rate for each calculation that was a function of the relative strength of, the different elements of value of each enterprise.

The software in block 432 checks the bot date table (149) and deactivates cash flow bots with creation dates before the current system date. The software in the block then retrieves the information from the system settings table (140) and the matrix data table (143) as part of the process of initializing cash flow bots for each enterprise in accordance with the frequency specified by the user (20) in the system settings table (140).

Bots are independent components of the application that have specific tasks to perform. In the case of cash flow bots, their primary tasks are to calculate the cash flow for each enterprise for every time period where data are available and to forecast a steady state cash flow for each enterprise in the organization. Cash flow is calculated using the forecast revenue, expense, capital change and depreciation data retrieved from the matrix data table (143) with a well-known formula where cash flow equals period revenue minus period expense plus the period change in capital plus non-cash depreciation/amortization for the period. The steady state cash flow for each enterprise is calculated for the enterprise using forecasting methods identical to those disclosed previously in U.S. Pat. No. 5,615,109 to forecast revenue, expenses, capital changes and depreciation separately before calculating the cash flow. Every cash flow bot contains the information shown in Table 32.

TABLE 32
1. Unique ID number (based on date, hour, minute, second of creation)
2. Creation date (date, hour, minute, second)
3. Mapping information
4. Storage location
5. Organization
6. Enterprise

After the cash flow bots are initialized, the bots activate in accordance with the frequency specified by the user (20) in the system settings table (140). After being activated the bots, retrieve the forecast data for each enterprise from the matrix data table (143) and then calculate a steady state cash flow forecast by enterprise. The resulting values by period for each enterprise are then stored in the cash flow table (141) in the application database (50) before processing advances to a block 433.

The software in block 433 checks the system settings table (140) in the application database (50) to determine if the current calculation is a new calculation or a structure change. If the calculation is not a new calculation or a structure change, then processing advances to a software block 445. Alternatively, if the calculation is new or a structure change, then processing advances to a software block 441.

The software in block 441 uses the cash flow by period data from the cash flow table (141) and the calculated requirement for working capital to calculate the value of excess cash and marketable securities for every time period by enterprise and stores the results of the calculation in the financial forecasts table (150) in the application database. The excess cash and marketable securities calculated in this step is added to the forecast investment balance by period by enterprise and stored in the financial forecasts table (150) before processing advances to a block 442.

The software in block 442 checks the bot date table (149) and deactivates financial value bots with creation dates before the current system date. The software in block 442 then retrieves the information from the system settings table (140) and the matrix data table (143) as part of the process of initializing financial value bots for the derivatives and investments in accordance with the frequency specified by the user (20) in the system settings table (140).

Bots are independent components of the application that have specific tasks to perform. In the case of financial value bots, their primary task is to calculate the contribution of every element of value, sub-element of value, element combination, value driver, external factor and factor combination to the derivative and investment segments of value by enterprise. The system of the present invention uses 12 different types of predictive models to determine relative contribution: neural network; CART; projection pursuit regression; generalized additive model (GAM); GARCH; MMDR; redundant regression network; boosted Naive Bayes Regression; the support vector method; MARS; linear regression; and stepwise regression. The model having the smallest amount of error as measured by applying the mean squared error algorithm to the test data are the best fit model. The “relative contribution algorithm” used for completing the analysis varies with the model that was selected as the “best-fit” as described previously. Every financial value bot activated in this block contains the information shown in Table 33.

TABLE 33
1. Unique ID number (based on date, hour, minute, second of creation)
2. Creation date (date, hour, minute, second)
3. Mapping information
4. Storage location
5. Organization
6. Enterprise
7. Derivative or Investment
8. Element, sub-element, factor, element combination, factor combination
or value driver
9. Predictive model type

After the software in block 442 initializes the financial value bots, the bots activate in accordance with the frequency specified by the user (20) in the system settings table (140). Once activated, they retrieve information and sub-divide the data into two sets, one for training and one for testing. The same set of training data are used by each of the different types of bots for each model. After the financial bots complete their processing, the software in block 442 saves the calculated value contributions in the matrix data table (143) by enterprise. The calculated value contributions by element or external factor for investments are also saved in the financial forecasts table (150) by enterprise in the application database (50) and processing advances to a block 443.

The software in block 443 checks the bot date table (149) and deactivates element life bots with creation dates before the current system date. The software in block 443 then retrieves the information from the system settings table (140) and the matrix data table (143) as part of the process of initializing element life bots for each element and sub-element of value for each enterprise in the organization being analyzed.

Bots are independent components of the application that have specific tasks to perform. In the case of element life bots, their primary task is to determine the expected life of each element and sub-element of value. There are three methods for evaluating the expected life of the elements and sub-elements of value:
1. Elements of value that are defined by a population of members or items (such as: channel partners, customers, employees and vendors) will have their lives estimated by analyzing and forecasting the lives of the members of the population. The forecasting of member lives will be determined by the “best” fit solution from competing life estimation methods including the Iowa type survivor curves, Weibull distribution survivor curves, Gompertz-Makeham survivor curves, polynomial equations using the methodology for selecting from competing forecasts disclosed in U.S. Pat. No. 5,615,169;
2. Elements of value (such as patents, long term supply agreements and insurance contracts) that have legally defined lives will have their lives calculated using the time period between the current date and the expiration date of the element or sub-element; and
3. Finally, elements of value and sub-elements of value (such as brand names, information technology and processes) that do not have defined lives and/or that may not consist of a collection of members will have their lives estimated as a function of the enterprise Competitive Advantage Period (CAP).
   In the latter case, the estimate will be completed using the element vector trends and the stability of relative element strength. More specifically, lives for these element types are estimated by: subtracting time from the CAP for element volatility that exceeds enterprise volatility and/or subtracting time for relative element strength that is below the leading position and/or relative element strength that is declining.

The resulting values are tagged and stored in the matrix data table (143) for each element and sub-element of value by enterprise. Every element life bot contains the information shown in Table 34.

TABLE 34
1. Unique ID number (based on date, hour, minute, second of creation)
2. Creation date (date, hour, minute, second)
3. Mapping information
4. Storage location
5. Organization
6. Enterprise
7. Element or sub-element of value
8. Life estimation method (item analysis, date calculation or relative
to CAP)

After the element life bots are initialized, they are activated in accordance with the frequency specified by the user (20) in the system settings table (140). After being activated, the bots retrieve information for each element and sub-element of value from the matrix data table (143) in order to complete the estimate of element life. The resulting values are then tagged and stored in the matrix data table (143) by enterprise in the application database (50) before processing advances to a block 445.

The software in block 445 checks the system settings table (140) in the application database (50) to determine if the current calculation is a new calculation or a structure change. If the calculation is not a new calculation or a structure change, then processing advances to a software block 502. Alternatively, if the calculation is new or a structure change, then processing advances to a software block 448.

The software in block 448 checks the bot date table (149) and deactivates component capitalization bots with creation dates before the current system date. The software in block 448 then retrieves the information from the system settings table (140) and the matrix data table (143) as part of the process of initializing component capitalization bots for each enterprise in the organization.

Bots are independent components of the application that have specific tasks to perform. In the case of component capitalization bots, their task is to determine the capitalized value of the components and subcomponents of value—forecast revenue, forecast expense or forecast changes in capital for each enterprise in the organization in accordance with the formula shown in Table 35.

TABLE 35

Value = F_{f1}/(1 + K) + F_{f2}/(1 + K)² + F_{f3}/(1 + K)³ + F_{f4}/(1 + K)⁴ +
(F_{f4} × (1 + g))/(1 + K)⁵) + (F_{f4} × (1 + g)²)/(1 + K)⁶) . . . +
(F_{f4} × (1 + g)^{N})/(1 + K)^{N+4})
Where:
F_{fx} = Forecast revenue, expense or capital requirements for year × after valuation date (from advanced finance system)
N = Number of years in CAP (from prior calculation)
K = Total average cost of capital − % per year (from prior calculation)
g = Forecast growth rate during CAP − % per year (from advanced financial system)

After the calculation of capitalized value of every component and sub-component of value is complete, the results are tagged and stored in the matrix data table (143) by enterprise in the application database (50). Every component capitalization bot contains the information shown in Table 36.

TABLE 36
1. Unique ID number (based on date, hour, minute, second of creation)
2. Creation date (date, hour, minute, second)
3. Mapping information
4. Storage location
5. Organization
6. Enterprise
7. Component of value (revenue, expense or capital change)
8. Sub component of value

After the component capitalization bots are initialized, they activate in accordance with the frequency specified by the user (20) in the system settings table (140). After being activated, the bots retrieve information for each component and sub-component of value from the matrix data table (143) in order to calculate the capitalized value of each component for each enterprise in the organization. The resulting values are then tagged and saved in the matrix data table (143) in the application database (50) by enterprise before processing advances to a block 449.

The software in block 449 checks the bot date table (149) and deactivates current operation bots with creation dates before the current system date. The software in block 449 then retrieves the information from the system settings table (140), the matrix data table (143) and the financial forecasts table (150) as part of the process of initializing bots for each element of value, sub-element of value, combination of elements, value driver and/or external factor for the current operation.

Bots are independent components of the application that have specific tasks to perform. In the case of current operation bots, their task is to calculate the contribution of every element of value, sub-element of value, element combination, external factor, factor combination and value driver to the current operation segment of value. For calculating the current operation portion of element value, the bots use the procedure outlined in Table 6. The first step in completing the calculation in accordance with the procedure outlined in Table 6, is determining the relative contribution of each element, sub-element, combination of elements or value driver by using a series of predictive models to find the best fit relationship between:
1. The element of value vectors, element combination vectors and external factor vectors, factor combination vectors and value drivers and the enterprise components of value they correspond to; and
2. The sub-element of value vectors and the element of value they correspond to.

The system of the present invention uses 12 different types of predictive models to identify the best fit relationship: neural network; CART; projection pursuit regression; generalized additive model (GAM); GARCH; MMDR; redundant regression network; boosted Naïve Bayes Regression; the support vector method; MARS; linear regression; and stepwise regression. The model having the smallest amount of error as measured by applying the mean squared error algorithm to the test data are the best fit model. The “relative contribution algorithm” used for completing the analysis varies with the model that was selected as the “best-fit”. For example, if the “best-fit” model is a neural net model, then the portion of revenue attributable to each input vector is determined by the formula shown in Table 37.

TABLE 37
$( {\sum }_{k = 1}^{k = m} {\sum }_{j = 1}^{j = n} {I}_{jk} X {O}_{k} \text{/} {\sum }_{j = 1}^{j = n} {I}_{ik} ) \text{/} {\sum }_{k = 1}^{k = m} {\sum }_{j = 1}^{j = n} {I}_{jk} X {O}_{k}$

Where
Iⱼₖ = Absolute value of the input weight from input node j to hidden node k
Oₖ = Absolute value of output weight from hidden node k
M = number of hidden nodes
N = number of input nodes

After the relative contribution of each element of value, sub-element of value, external factor, element combination, factor combination and value driver to the components of current operation value is determined, the results of this analysis are combined with the previously calculated information regarding element life and capitalized component value to complete the valuation of the current operation contribution of each: element of value, sub-element of value, external factor, element combination, factor combination and/or value driver using the approach shown in Table 6.

The resulting values are tagged and stored in the matrix data table (143) for each element of value, sub-element of value, element combination, factor combination and value driver by enterprise. For external factor and factor combination value calculations, the external factor percentage is multiplied by the capitalized component value to determine the external factor value. The resulting values for external factors are also tagged and saved in the matrix data table (143) by enterprise: Every current operation bot contains the information shown in Table 38.

TABLE 38
1. Unique ID number (based on date, hour, minute, second of creation)
2. Creation date (date, hour, minute, second)
3. Mapping information
4. Storage location
5. Organization
6. Enterprise
7. Element, sub-element, factor, element combination, factor combination
or value driver
8. Component of value (revenue, expense or capital change)

After the current operation bots are initialized by the software in block 449 they activate in accordance with the frequency specified by the user (20) in the system settings table (140). After being activated, the bots retrieve information and complete the valuation for the component of value being analyzed. As described previously, the resulting values are then tagged and saved in the matrix data table (143) in the application database (50) by enterprise before processing advances to a block 451.

The software in block 451 checks the bot date table (149) and deactivates event risk bots with creation dates before the current system date. The software in the block then retrieves the information from the system settings table (140) and the matrix data table (143) as part of the process of initializing event risk bots for each enterprise in accordance with the frequency specified by the user (20) in the system settings table (140). Bots are independent components of the application that have specific tasks to perform. In the case of event risk bots, their primary task is to forecast the frequency and severity of event risks by enterprise. In addition to forecasting insured risks, the system of the present invention also uses historical data to forecast “non-insured” standard risk such as the risk of employees resigning and the risk of customers defecting. The system of the present invention uses the forecasting methods disclosed in related U.S. Pat. No. 5,615,109 for standard event risk forecasting and the game theoretic real options models discussed in related U.S. patent Ser. No. 10/036,522 for strategic risk forecasting. Every event risk bot contains the information shown in Table 39.

TABLE 39
1. Unique ID number (based on date, hour, minute, second of creation)
2. Creation date (date, hour, minute, second)
3. Mapping information
4. Storage location
5. Organization
6. Enterprise
7. Type: standard or strategic
8. Forecast method: multivalent combination of forecasts or game
theoretic real option

After the event risk bots are initialized, the bots activate in accordance with the frequency specified by the user (20) in the system settings table (140). After being activated the bots, retrieve the data from the matrix data table (143) and then forecast the frequency and severity of the event risks. The resulting forecasts for each enterprise are then stored in the matrix data table (143) before processing advances to a software block 452 where statistics are calculated.

The software in block 452 checks the bot date table (149) and deactivates statistical bots with creation dates before the current system date. The software in block 452 then retrieves the information from the system settings table (140) and the matrix data table (143) as part of the process of initializing statistical bots for each causal value driver and event risk. Bots are independent components of the application that have specific tasks to perform. In the case of statistical bots, their primary tasks are to calculate and store statistics such as mean, median, standard deviation, slope, average period change, maximum period change, variance and covariance between each causal value driver, standard event risk and the S&P 500. Every statistical bot contains the information shown in Table 40.

TABLE 40
1. Unique ID number (based on date, hour, minute, second of creation)
2. Creation date (date, hour, minute, second)
3. Mapping information
4. Storage location
5. Organization
6. Enterprise
7. Value driver or standard event risk

### When bots in block 452 have calculated, tagged and stored statistics for each causal value driver and event risk in the matrix data table (143) by enterprise, processing advances to a software block 453.

The software in block 453 checks the bot date table (149) and deactivates extreme value bots with creation dates before the current system date. The software in block 453 then retrieves the information from the system settings table (140) and the matrix data table (143) as part of the process of initializing extreme value bots in accordance with the frequency specified by the user (20) in the system settings table (140).

Bots are independent components of the application that have specific tasks to perform. In the case of extreme value bots, their primary task is to identify the extreme values for each causal value driver. The extreme value bots use the Blocks method and the peak over threshold method to identify extreme values. Other extreme value algorithms can be used to the same effect. Every extreme value bot activated in this block contains the information shown in Table 41.

TABLE 41
1. Unique ID number (based on date, hour, minute, second of creation)
2. Creation date (date, hour, minute, second)
3. Mapping information
4. Storage location
5. Organization
6. Enterprise
7. Method: blocks or peak over threshold
8. Value driver or external factor

After the extreme value bots are initialized, they activate in accordance with the frequency specified by the user (20) in the system settings table (140). Once activated, they retrieve information and determine the extreme value range for each value driver or external factor. The bot tags and saves the extreme values for each causal value driver and external factor in the matrix data table (143) by enterprise in the application database (50) and processing advances to a block 454.

The software in block 454 checks the bot date table (149) and deactivates forecast update bots with creation dates before the current system date. The software in block 453 then retrieves the information from the system settings table (140) and the matrix data table (143) as part of the process of initializing forecast bots in accordance with the frequency specified by the user (20) in the system settings table (140).

Bots are independent components of the application that have specific tasks to perform. In the case of forecast update bots, their task is to compare the forecasts stored for external factors and financial asset values (subset of investments) with the information available from futures exchanges. Every forecast update bot activated in this block contains the information shown in Table 42.

TABLE 42
1. Unique ID number (based on date, hour, minute, second of creation)
2. Creation date (date, hour, minute, second)
3. Mapping information
4. Storage location
5. Organization
6. Enterprise
7. External factor or financial asset
8. Forecast time period

After the forecast update bots are initialized, they activate in accordance with the frequency specified by the user (20) in the system settings table (140). Once activated, they retrieve information and determine if any forecasts need to be changed to bring them in line with the market data on future values. The bots save the updated forecasts in the appropriate tables in the application database (50) by enterprise and processing advances to a block 455.

The software in block 455 checks the bot date table (149) and deactivates scenario bots with creation dates before the current system date. The software in block 455 then retrieves the information from the system settings table (140) and the matrix data table (143) as part of the process of initializing scenario bots in accordance with the frequency specified by the user (20) in the system settings table (140).

Bots are independent components of the application that have specific tasks to perform. In the case of scenario bots, their primary task is to identify likely scenarios for the evolution of the causal value drivers and event risks by enterprise. The scenario bots use information from the advanced finance system, external databases and the forecasts completed in the prior stage to obtain forecasts for specific value drivers and event risks before using the covariance information stored in the matrix data table (143) to develop forecasts for the other causal value drivers and risks under normal conditions. They also use the extreme value information calculated by the previous bots and stored in the matrix data table (143) to calculate extreme scenarios. Every scenario bot activated in this block contains the information shown in Table 43.

TABLE 43
1. Unique ID number (based on date, hour, minute, second of creation)
2. Creation date (date, hour, minute, second)
3. Mapping information
4. Storage location
5. Type: normal, extreme
6. Organization
7. Enterprise

After the scenario bots are initialized, they activate in accordance with the frequency specified by the user (20) in the system settings table (140). Once activated, they retrieve information and develop a variety of scenarios as described previously. After the scenario bots complete their calculations, they save the resulting scenarios in the scenarios table (152) by enterprise in the application database (50) and processing advances to a block 456. If a most likely scenario has been specified by the user (20) in the system settings table (140), then the values for that scenario are calculated using a weighted sum of the normal and extreme scenarios based on the percentages specified by the user (20). The resulting “most likely” scenario is also salved in the scenarios table (152) in the application database (50).

The software in block 456 checks the bot date table (149) and deactivates simulation bots with creation dates before the current system date. The software in block 456 then retrieves the information from the system settings table (140), the matrix data table (143) and the scenarios table (152) as part of the process of initializing simulation bots in accordance with the frequency specified by the user (20) in the system settings table (140).

Bots are independent components of the application that have specific tasks to perform. In the case of simulation bots, their primary task is to run three different types of simulations for the enterprise. The simulation bots run probabilistic simulations of organizational financial performance and valuation by segment of value for each enterprise using: the normal scenario and the extreme scenario if no most likely scenario has been specified. If a most likely scenario has been specified, then that scenario is used. They also run an unconstrained genetic algorithm simulation that evolves to the most negative value possible over the specified time period. In one embodiment, Monte Carlo models are used to complete the probabilistic simulation, however other probabilistic simulation models such as Quasi Monte Carlo can be used to the same effect. The models are initialized using the statistics and relationships derived from the calculations completed in the prior stages of processing to relate segment value to the value driver and standard event risk scenarios. Every simulation bot activated in this block contains the information shown in Table 44.

TABLE 44
1. Unique ID number (based on date, hour, minute, second of creation)
2. Creation date (date, hour, minute, second)
3. Mapping information
4. Storage location
5. Type: normal, extreme, most likely and/or unconstrained genetic
algorithm
6. Segment of value: current operation, investments or derivatives
7. Organization
8. Enterprise

After the simulation bots are initialized, they activate in accordance with the frequency specified by the user (20) in the system settings table (140). Once activated, they retrieve information and simulate the financial performance of the different segments of value of the organization by enterprise over the time periods specified by the user (20) in the system settings table (140). In doing so, the bots will forecast the range of risk and return that can be expected from each segment of value by enterprise within the confidence interval defined by the user (20) in the system settings table (140) for each scenario. After the simulation bots complete their calculations, the resulting forecasts are saved in the matrix data table (143), the summary data table (156) and the simulation table (157) by enterprise in the application database (50) and processing advances to a block 457.

The software in block 457 checks the bot date table (149) and deactivates options simulation bots with creation dates before the current system date. The software in block 457 then retrieves the information from the system settings table (140), the matrix data table (143) and the scenarios table (152) as part of the process of initializing option simulation bots in accordance with the frequency specified by the user (20) in the system settings table (140).

Bots are independent components of the application that have specific tasks to perform. In the case of option simulation bots, their primary task is to run up to four different types of simulations for the enterprise real options, contingent liabilities and strategic risks. The option simulation bots run a normal scenario and an extreme scenario if a most likely scenario has not been specified. If a most likely scenario has been specified, then it is used in the option simulations. In either case an unconstrained genetic algorithm simulation that evolves to the most negative value possible over the specified time period is analyzed. The bots also run sensitivity analyses to determine the effect of each value driver and event risk on option valuation under each scenario. In one embodiment, Monte Carlo models are used to complete the probabilistic simulation, however other probabilistic simulation models such as Quasi Monte Carlo can be used to the same effect. The models are initialized specifications used in the baseline calculations. Every option simulation bot activated in this block contains the information shown in Table 45.

TABLE 45
1. Unique ID number (based on date, hour, minute, second of creation)
2. Creation date (date, hour, minute, second)
3. Mapping information
4. Storage location
5. Type: normal, extreme, unconstrained genetic algorithm or sensitivity
6. Option type: real option, contingent liability or strategic risk
7. Organization
8. Enterprise

After the option simulation bots are initialized, they activate in accordance with the frequency specified by the user (20) in the system settings table (140). Once activated, they retrieve information and simulate the financial performance of the different types of options over the time periods specified by the user (20) in the system settings table (140). In doing so, the bots will forecast the range of values that can be expected from each option type by enterprise within the confidence interval defined by the user (20) in the system settings table (140) for each scenario. The data from the sensitivity bots help distribute the factor risk and element risk by option. After the option simulation bots complete their calculations, the resulting forecasts are saved in the matrix data table (143), the summary data table (156) and the simulation table (157) by enterprise in the application database (50) and processing advances to a block 458.

The software in block 458 checks the bot date table (149) and deactivates segmentation bots with creation dates before the current system date. The software in the block then retrieves the information from the system settings table (140), the matrix data table (143) and the simulation table (157) as part of the process of initializing segmentation bots for each enterprise in accordance with the frequency specified by the user (20) in the system settings table (140). Bots are independent components of the application that have specific tasks to perform. In the case of segment bots, their primary task is to use the historical data and simulation data segment the value of each element, factor, element combination, factor combination and value driver into a base value and a variability or risk component. The system of the present invention uses wavelet algorithms to segment the value into two components although other segmentation algorithms such as GARCH could be used to the same effect. Every segmentation bot contains the information shown in Table 46.

TABLE 46
1. Unique ID number (based on date, hour, minute, second of creation)
2. Creation date (date, hour, minute, second)
3. Mapping information
4. Storage location
5. Organization
6. Enterprise
7. Element, sub-element, factor, element combination, factor combination
or value driver
8. Segmentation algorithm

After the segmentation bots are initialized, the bots activate in accordance with the frequency specified by the user (20) in the system settings table (140). After being activated the bots retrieve the data from the matrix data table (143) and then segment the value of each element, factor, element combination, factor combination or value driver into two segments. The resulting values by period for each enterprise are then stored in the matrix data table (143). As part of this processing the factor risk assignments stored by the user (20) after interacting with the software in block 421 are used to distribute factor risks to the elements of value before processing advances to a software block 465 where the event risks are analyzed.

The software in block 465 checks the bot date table (149) and deactivates market risk bots with creation dates before the current system date. The software in the block then retrieves the information from the system settings table (140) and the matrix data table (143) as part of the process of initializing market risk bots for the market portfolio and for each enterprise with a market value in accordance with the frequency specified by the user (20) in the system settings table (140). Bots are independent components of the application that have specific tasks to perform. In the case of market risk bots, their tasks are to determine the implied market risk for the analysis time periods for the market portfolio and for each equity of each enterprise with a public market value and to determine the market price of a unit of risk. The market price of risk is the excess return the market requires per unit of volatility. This value can be calculated using the traditional capital asset pricing model in a manner that is well known. The implied risk of each equity is determined using the Black Scholes option pricing algorithm. The Black Scholes algorithm determines the price for an equity option as a function of several variables including the volatility of the equity. When the market price and the other variables in the equation are known, then the Black Scholes algorithm can be used to calculate the implied volatility in the equity. Under the traditional capital asset pricing model volatility equals market risk. Three moment and game-theoretic capital asset pricing models can also be used to calculate an overall market risk measure to the same effect. Every market risk bot contains the information shown in Table 47.

TABLE 47
1. Unique ID number (based on date, hour, minute, second of creation)
2. Creation date (date, hour, minute, second)
3. Mapping information
4. Storage location
5. Organization
6. Enterprise or market portfolio
7. Time period(s)
8. Overall market risk measure: implied option volatility

After the market risk bots are initialized, the bots activate in accordance with the frequency specified by the user (20) in the system settings table (140). After being activated the bots, retrieve the data for each enterprise with a market price from the matrix data table (143) and then calculate the implied volatility for each time period. They also calculate the market price of risk implied by the current price levels. The market price of risk is then combined with the implied volatilities to calculate the market value of risk for each time period. The resulting values for each time period are then stored in the matrix data table (143) for the market portfolio and for each enterprise before processing advances to a software block 469 where market volatility is calculated.

The software in block 469 checks the bot date table (149) and deactivates market volatility bots with creation dates before the current system date. The software in the block then retrieves the information from the system settings table (140) and the matrix data table (143) as part of the process of initializing market volatility bots for the organization in accordance frequency specified by the user (20) in the system settings table (140). Bots are independent components of the application that have specific tasks to perform. In the case of market volatility bots they have two primary tasks. The first task is to transform the previously completed calculations regarding event risk, strategic event risk element variability risk and factor variability risk into,forms where they can be added together. The transformation of the risks is completed by first transforming the event risk information to normal variables. The transformed risk is then combined with the market price of risk information derived previously so that the layers of the event risks can be more readily compared with the element and factor variability data. The second task is to compare the implied market risk calculated by the bots in block 465 with the summed total of the event, contingent event, strategic event, element, factor and base market (or industry market) risks for the specified time periods. As discussed previously, market volatility is defined as the difference between market risk and the total of all other types of risk. If the organization does not have a market value, then the bots only complete the first task so that the overall total risk can be calculated. Every market volatility bot contains the information shown in Table 48.

TABLE 48
1. Unique ID number (based on date, hour, minute, second of creation)
2. Creation date (date, hour, minute, second)
3. Mapping information
4. Storage location
5. Organization
6. Enterprise
7. Time Period(s)

After the market volatility bots are initialized, the bots activate in accordance with the frequency specified by the user (20) in the system settings table (140). After being activated the bots, retrieve the data for the organization from the matrix data table (143) and then calculate the total of the event, element variability and factor variability risks after the transformations have been completed. If there is a market price, then the value of the market volatility is also calculated. The, resulting values for each time period for each enterprise and the organization are then stored in the matrix data table (143) in the application database (50) before processing advances to a software block 470.

The software in block 470 calculates the values for a number of the cells in the market value matrix. First, the software in block 470 uses the results of the sensitivity analysis completed by the option bots in block 457 to calculate the impact of each element of value and external factor on the real option segment of value and save the resulting values in the matrix data table (143). It then uses the factor risk assignments developed by the software in block 421 to assign factor risks to the appropriate elements of value and save the results in the matrix data table (143). Finally, the software in block 470 uses the formula shown in Table 49 to calculate the Current Operation Going Concern Value.

TABLE 49

Current Operation Going Concern Value = Total Current Operation
Value − Σ Financial Asset Values − Σ Elements of
Value − Σ External Factors − Σ Current Operation Risks

After the current operation going concern value is calculated, the resulting value is saved in the matrix data table (143) before processing advances to a software block 471.

The software in block 471 checks the bot date table (149) and deactivates value sentiment bots with creation dates before the current system date. The software in block 471 then retrieves the information from the system settings table (140) and the matrix data table (143) as part of the process of initializing sentiment calculation bots for the organization. Bots are independent components of the application that have specific tasks to perform. In the case of sentiment calculation bots, their task is to retrieve data and then calculate the value of sentiment for each enterprise in accordance with the formula shown in Table 50.

TABLE 50

Value of Market Sentiment = Market Value for
Enterprise − Current Operation Value − ΣReal Option
Values − ΣValue of Investments − Σ Derivative
Values − Market Value of Risk

Organizations that are not public corporations will, of course not have a market value so no calculation will be completed for these enterprises. The market sentiment for the organization will be calculated by subtracting the total for each of the other four segments of value and the market value of risk for all enterprises in the organization from the total market value for all enterprises in the organization. Every value sentiment bot contains the information shown in Table 51.

TABLE 51
1. Unique ID number (based on date, hour, minute, second of creation)
2. Creation date (date, hour, minute, second)
3. Mapping information
4. Storage location
5. Organization
6. Enterprise
7. Type: Organization or Enterprise

After the value sentiment bots are initialized, they activate in accordance with the frequency specified by the user (20) in the system settings table (140). After being activated, the bots retrieve information from the system settings table (140), the matrix data table (143) and the financial forecasts table (150) in order to complete the sentiment calculation for each enterprise and the organization. After the calculation is complete, the resulting values are tagged then saved in the matrix data table (143) in the application database (50) before processing advances to a block 473.

The software in block 473 checks the bot date table (149) and deactivates sentiment analysis bots with creation dates before the current system date. The software in block 473 then retrieves the information from the system settings table (140), the matrix data table (143) and the vector table (153) as part of the process of initializing sentiment analysis bots for the enterprise. Bots are independent components of the application that have specific tasks to perform. In the case of sentiment analysis bots, their primary task is to determine the composition of the calculated sentiment for each enterprise in the organization and the organization as a whole. One part of this analysis is completed by comparing the portion of overall market value that is driven by the different elements of value as determined by the bots in software block 429 and the calculated valuation impact of each element of value on the segments of value as shown below in Table 52.

TABLE 52
Total Enterprise Market Value = $100 Billion, 10% driven by Brand
factors
Implied Brand Value = $100 Billion × 10% = $10 Billion
Brand Element Current Operation Value = $6 Billion
Increase/Decrease in Enterprise Real Option Values* Due to
Brand = $1.5 Billion
Increase/(Decrease) in Derivative Values due to Brands = $0.0
Increase/(Decrease) in investment Values due to Brands = $0.25 Billion
Brand Sentiment = $10 − $6 − $1.5 − $0.0 − $0.25 = $2.25 Billion
*includes allocated industry options when used in the calculation

The sentiment analysis bots also determine the impact of external factors on sentiment. Every sentiment analysis bot contains the information shown in Table 53.

TABLE 53
1. Unique ID number (based on date, hour, minute, second of creation)
2. Creation date (date, hour, minute, second)
3. Mapping information
4. Storage location
5. External factor or element of value
6. Organization
7. Enterprise

After the sentiment analysis bots are initialized, they activate in accordance with the frequency specified by the user (20) in the system settings stable (140). After being activated, the bots retrieve information from the system settings table (140), the matrix data table (143) and the financial forecasts table (150) in order to analyze sentiment. The resulting breakdown of sentiment is tagged then saved in the matrix data table (143) by enterprise in the application database (50). Sentiment at the organization level is calculated by adding together the sentiment calculations for all the enterprises in the organization. The results of this calculation are also tagged and saved in the matrix data table (143) in the application database (50) before processing advances to a block 475

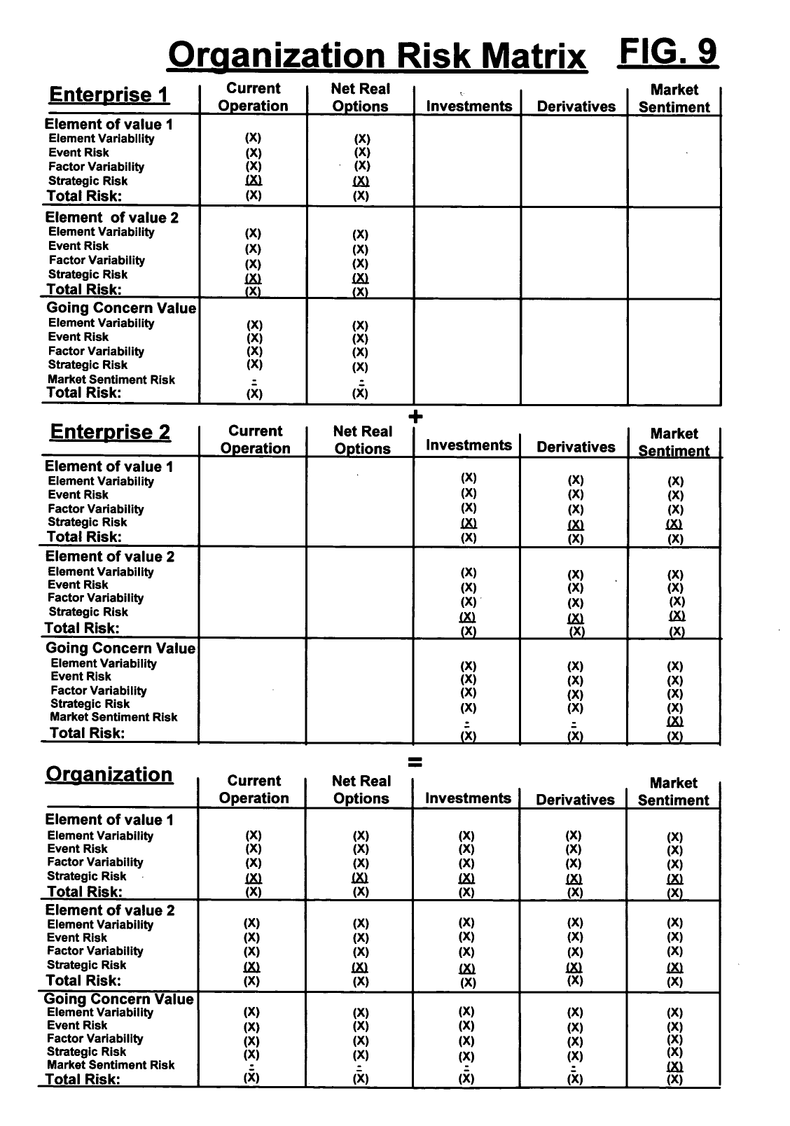

Before going on to discuss organization optimization calculations is appropriate to briefly review the processing that has been completed so far. At this point, the organization risk matrix (FIG. 9) and the market value matrix (FIG. 10) have been filled in with values for the organization at the date of system calculation (assumes complete set of data up to and including the date of system calculation has been processed). As detailed above, the matrix of risk includes six types of risk—the risk associated with element variability, factor variability, standard events, strategic events, the base market (or industry market) portfolio and market volatility. To the extent possible, the factor variability risk, event risk, strategic event risk standard event risk and market volatility have been placed in the matrix cell that corresponds to the element of value and segment of value that the risk corresponds to. External factors that have value as well as all other risks that have not been distributed to an element of value are left in the “going concern” element of value. In addition to giving organizations a new, level of control over the management of their operational and financial performance. The system of the present invention also greatly enhances the ability to develop: securities that bundle risks together for resale, securities that mix risk transfer products with equity ownership, services that transfer risk in an automated fashion and strong working relationships with external partners.

The software in block 475 checks the system settings table (140) in the application database (50) to determine if the current calculation is a new, calculation or a structure change. If the calculation is not a new calculation or a structure change, then processing advances to a software block 502. Alternatively, if the calculation is new or a structure change, then processing advances to a software block 476.

The software in block 476 checks the bot date table (149) and deactivates optimization bots with creation dates before the current system date. The software in block 476 then retrieves the information from the system settings table (140), the matrix data table (143), the scenarios table (152) and the simulation table (157) that is used to initialize value optimization bots in accordance with the frequency specified by the user (20) in the system settings table (140).

Bots are independent components of the application that have specific tasks to perform. In the case of optimization bots, their primary task is to determine the optimal mix of features for the organization under a variety of scenarios for the specified time period (or time periods). The optimal mix of features is the mix that maximizes the value of the market value matrix at the end of the given time period. A mixed integer non linear optimization is used to determine the best mix of features for each scenario and time period combination. Other optimization algorithms such as genetic algorithms can be used at this point to achieve the same result. Every optimization bot contains the information shown in Table 54.

TABLE 54
1. Unique ID number (based on date, hour, minute, second of creation)
2. Creation date (date, hour, minute, second)
3. Mapping information
4. Storage location
5. Organization
6. Scenario: normal, extreme and most likely
7. Time period

After the software in block 476 initializes the optimization bots, they activate in accordance with the frequency specified by the user (20) in the system settings table (140). After completing their calculations, the resulting feature mix for each scenario and is saved in the summary data table (156) in the application database (50) by enterprise. The shadow prices from these optimizations are also stored in the feature rank table (158) by enterprise for use in identifying new features and feature options that the company may wish to develop and/or purchase. After the results of this optimization are stored in the application database (50) by enterprise, processing advances to a software block 475.

The software in block 478 checks the bot date table (149) and deactivates feature rank bots with creation dates before the current system date. The software in block 478 then retrieves the information from the system settings table (140), the matrix data table (143), the summary data table (156) and the feature rank table (158) as part of the process of initializing feature rank bots for every feature and causal value driver.

Bots are independent components of the application that have specific tasks to perform. In the case of feature rank bots, their primary task is to rank all of the features, feature options and causal value drivers that the organization can change to improve value and/or reduce risk. Causal value drivers are analyzed to give the user (20) insight into actions that may improve value that haven't been identified as features. The feature rank bots rely on the market value matrix developed in the prior stage of processing to rank all of the different features and feature options that are available to the system for financial measurement, management and optimization. Every feature, feature option and value driver is ranked on the basis its value impact; risk impact and overall value impact net of investment for each scenario. Features, options and value drivers are also ranked on the basis of capital efficiency which is their overall value impact before deducting capital investment over the capital investment required to implement the feature or feature option. Features, options and value drivers that do not require capital investment will have their value impact divided by 0.01 to determine their capital efficiency ranking. Every feature rank bot contains the information shown in Table 55.

TABLE 55
1. Unique ID number (based on date, hour, minute, second of creation)
2. Creation date (date, hour, minute, second)
3. Mapping information
4. Storage location
5. Organization
6. Scenario: normal, extreme and most likely
7. Feature, feature option or causal value driver

After the software in block 478 initializes the feature rank bots, they activate in accordance with the frequency specified by the user (20) in the system settings table (140). After completing their calculations, the bots store the ranking for every feature, feature option and causal value driver in the feature rank table (158) by enterprise before processing advances to a software block 481.

The software in block 481 checks the bot date table (149) and deactivates frontier bots with creation dates before the current system date. The software in block 481 then retrieves the information from the system settings table (140), the matrix data table (143), the summary data table (156) and the feature rank table (158) as part of the process of initializing frontier bots for each scenario.

Bots are independent components of the application that have specific tasks to perform. In the case of frontier bots, their primary task is to define the efficient frontier for organization financial performance under each scenario. The top leg of the efficient frontier for each scenario is defined by successively adding the features, options and value drivers that increase value while increasing risk to the optimal mix in capital efficiency order. The bottom leg of the efficient frontier for each scenario is defined by successively adding the features, options and value drivers that decrease value while decreasing risk to the optimal mix in capital efficiency order. Every frontier bot contains the information shown in Table 56.

TABLE 56
1. Unique ID number (based on date, hour, minute, second of creation)
2. Creation date (date, hour, minute, second)
3. Mapping information
4. Storage location
5. Organization
6. Scenario: normal, extreme and most likely
7. Feature, feature option or causal value driver

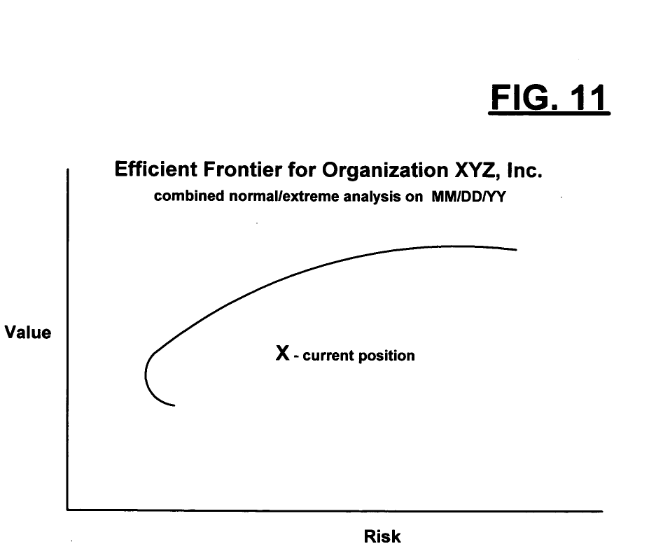

After the software in block 481 initializes the feature rank bots, they activate in accordance with the frequency specified by the user (20) in the system settings table (140). After completing their calculations, the results of all 3 sets of calculations (normal, extreme and most likely) are saved in the report table (155) in sufficient detail to generate a chart like the one shown in FIG. 11 before processing advances to a block 502.

### Analysis & Output

The flow diagram in FIG. 7 details the processing that is completed by the portion of the application software (500) that generates the market value matrix for the organization, generates a summary of the value, risk and liquidity for the organization, analyzes changes in organization structure and operation and optionally displays and prints management reports detailing the value matrix, risk matrix and the efficient frontier. Processing in this portion of the application starts in software block 502.

The software in block 502 retrieves information from the system settings table (140), the cash flow table (141), the matrix data table (143) and the financial forecasts table (150) that is used to calculate the minimum amount of working capital that will be available during the forecast time period. The system settings table (140) contains the minimum amount of working capital that the user (20) indicated was required for enterprise operation while the cash flow table (141) contains a forecast of the cash flow of the enterprise for each period during the forecast time period (generally the next 36 months). A summary of the available cash and cash deficits by currency, by month, for the next 36 months is stored in a summary xml format in the summary data table (156) by enterprise during this stage of processing. After the amount of available cash for each enterprise and the organization is calculated and stored in the feature rank table (158), processing advances to a software block 503.

The software in block 452 retrieves information from the matrix data table (143), financial forecasts table (150) and the summary data table (156) in order to generate the market value matrix (FIG. 10) by enterprise for the organization for each scenario. The matrices are stored in the report table (155) and a summary version of the data are added to the summary data table (156). The software in this block also creates and displays a summary Market Value Map™ Report and a risk and return analysis for the organization via the analysis definition window (708). The software in the block then prompts the user (20) via the analysis definition window (708) to specify changes in the organization that should be analyzed. The user (20) is given the option of: adding new features and feature options, re-defining the structure for analysis purposes, examining the impact of changes in segments of value, components of value, elements of value and/or external factors on organization market value. For example, the user (20) may wish to:
1. Redefine the efficient frontier without considering the impact of market sentiment on organization value—this analysis would be completed by temporarily re-defining the structure and completing a new analysis;
2. Redefine the efficient frontier after adding in the market value matrix for another enterprise that may be purchased—this analysis would be completed by temporarily re-defining the structure and completing a new analysis;
3. Forecast the likely impact of a project on organization value and risk—this analysis would be completed by mapping the expected results of the project to the market value matrix and then repeating the processing to determine if the organization would be closer to or further from the original efficient frontier after project implementation;
4. Forecast the impact of changing economic conditions on the organizations ability to repay its debt—this analysis would be completed by mapping the expected changes to organization market value matrix, recalculating value, liquidity and risk and then determining if the organization will in a better position to repay its debt; or
5. Maximize revenue from all enterprises in the organization—this analysis would be completed by temporarily defining a new structure that included only the revenue component of value and repeating the processing described previously.

The software in block 503 saves the analysis definitions the user (20) specifies in the analysis definition table (148) in the application database (50) before processing advances to a software block 506.

The software in block 506 checks the analysis definition table (148) in the application database (50) to determine if the user (20) has specified an analysis for computation. If an analysis has been specified, then processing returns to block 303 and the processing described previously is repeated with the changes defined in the analysis definition table being used in completing system calculations. After the analysis run is completed, the software in block 508 displays the results of the analysis via the analysis definition window (708) before processing advances to a software block 510. Alternatively, if the user (20) did not request an analysis, then processing advances directly to a software block 510.

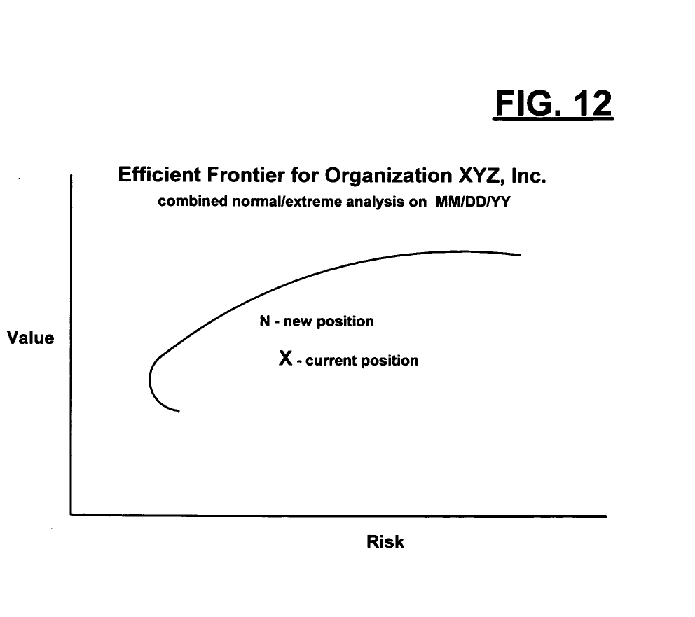

The software in block 510 prompts the user (20) to optionally select reports for display and/or printing using one or more frames. The format of the reports is either graphical, numeric or both depending on the type of report the user (20) specified in the system settings table (140). Typical formats for graphical reports displaying the efficient frontier are shown in FIG. 11 and FIG. 12. The user can also choose to have reports displayed and/or printed that compare the actual and forecast risk and return for the organization to the risk and return for the benchmark return previously saved in the benchmark return table (147). The report can also show if the expected return from the organization differs from the return that would be expected given the difference, between the risk of the organization and the risk of the market portfolio. The expected difference in return can be calculated using the different versions of the capital asset pricing model. If the user (20) selects any reports for printing, then the information regarding the selected reports is saved in the report table (155). After the user (20) has finished selecting reports, the selected reports are displayed to the user (20). After the user (20) indicates that the review of the reports has been completed, processing advances to a software block 511.

The software in block 511 prompts the user (20) to optionally review the new market value matrix information by frame and the responses to partner requests before they are released to the software in block 210 for distribution. After the review is complete processing passes to a software block 512. The processing can also pass to block 512 if the maximum amount of time to wait for no response specified by the user (20) in the system settings table is exceeded and the user (20) has not responded.

The software in block 512 checks the report table (155) to determine if any reports have been designated for printing. If reports have been designated for printing, then processing advances to a block 515. It should be noted that in addition to standard reports like the market value matrix (FIG. 10), the matrix of organization risk (FIG. 9), the Market Value Map™ report and the graphical depictions of the efficient frontier shown in FIG. 11 and FIG. 12, the system of the present invention can generate reports that rank the elements, external factors and/or the risks in order of their importance to market value and/or market risk by enterprise, by segment of value and/or for the organization as a whole. The system can also produce “metrics” reports by tracing the historical measures for value drivers over time. The software in block 515 sends the designated reports to the printer (118). After the reports have been sent to the printer (118), processing advances to a software block 517. Alternatively, if no reports were designated for printing, then processing advances directly from block 512 to block 517.

The software in block 517 checks the system settings table (140) to determine if the system is operating in a continuous run mode. If the system is operating in a continuous run mode, then processing returns to block 303 and the processing described previously is repeated in accordance with the frequency specified by the user (20) in the system settings table (140). Alternatively, if the system is not running in continuous mode, then the processing advances to a block 518 where the system stops.

Thus, the reader will see that the system and method described above transforms disparate narrow systems and knowledge bases into an integrated system for measuring and optimizing the financial performance of a multi-enterprise organization. The level of detail, breadth and speed of the financial analysis gives users of the integrated system the ability to manage their operations in an fashion that is superior to any method currently available to users of the isolated, narrowly focused management systems.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A learning system, comprising:
a plurality of computers connected by a network each with a processor having circuitry to execute instructions; a storage device available to each processor with sequences of instructions stored therein, which when executed cause the processors to:
integrate organization related data in accordance with a common schema, quantify the impact of elements of value, external factors and risks on organization share price by segment of value by learning from said data, and use said quantifications to identify a price for trading said shares.

2. The system of claim 1 where further system processing identifies the inter-relationship between elements of value, external factors and risks for each segment of value by learning from the data.

3. The system of claim 2 where further system processing combines the common schema with the quantified inter-relationships to develop an organization ontology.

4. The system of claim 1 where an organization is a single product, a group of products, a division, a company, a multi-company corporation, a value chain or a collaboration.

5. The system of claim 1 where the organization related data is obtained from the group consisting of advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems and combinations thereof.

6. The system of claim 1 where the common schema further comprises an xml schema.

7. The system of claim 1 where elements of value are selected from the group consisting of: alliances, brands, channels, content, customers, customer relationships, employees, employee relationships, information technology, intellectual property, knowledge, partnerships, processes, technology, vendors and vendor relationships.

8. The system of claim 1 where the total value of the segments of value equals market value and the segments of value are from the group consisting of current operation, derivatives, investments, real options, market sentiment and combinations thereof.

9. The system of claim 1 where the sum of the risks equals total risk associated with the organization share price and the risks are selected from the group consisting of event risks, external factor variability risks, element variability risks, strategic risks, contingent liabilities, market volatility and combinations thereof.

10. The system of claim 1 where external factors are selected from the group consisting of numerical indicators of conditions external to the organization, numerical indicators of prices external to the organization, numerical indicators of organization conditions compared to external expectations of organization conditions, numerical indicators of the organization performance compared to external expectations of organization performance and combinations thereof.

11. The system of claim 3 where the ontology is an rdf ontology.

12. An organization method, comprising:
integrating organization related data in accordance with a common schema,
developing a market value matrix by learning from organization data, information and knowledge, and
simulating organization financial performance using said matrix to identify changes that will optimize one or more aspects of organization risk, return and value.

13. The method of claim 12 where an organization is a single product, a group of products, a division, a company, a multi-company corporation, a value chain or a collaboration.

14. The method of claim 12 where the aspects of organization risk, return and value are selected from the group consisting of alliance risk, brand risk, channel risk, content risk, contingent liabilities, customer risk, customer relationship risk, current operation risk, derivative risk, employee risk, employee relationship risk, energy risk, enterprise risk, external factor risk, event risk, fraud risk, information technology risk, intellectual property risk, investment risk, knowledge risk, market sentiment risk, market risk, market volatility, organization risk, partnership risk, process risk, production equipment risk, product risk, real option risk, technology risk, vendor risk, vendor relationship risk, weather risk, alliance return, brand return, channel return, content return, contingent liabilities, customer return, customer relationship return, current operation return, derivative return, employee return, employee relationship return, enterprise return, external factor return, event return, information technology return, intellectual property return, investment return, knowledge return, market sentiment return, market return, market volatility, organization return, partnership return, process return, production equipment return, product return, real option return, technology return, vendor return, vendor relationship return, alliance value, brand value, channel value, content value, contingent liabilities, customer value, customer relationship value, current operation value, derivative value, employee value, employee relationship value, enterprise value, external factor value, event value, information technology value, intellectual property value, investment value, knowledge value, market sentiment value, market value, market volatility, organization value, partnership value, process value, production equipment value, product value, real option value, technology value, vendor value, vendor relationship value and combinations thereof.

15. The method of claim 12 that further comprises implementing the one or more changes in an automated fashion where implementation includes activities from the group consisting of narrow system changes, risk transfer, price changes, investment sales, derivative purchases, stock sales, changes in operation and combinations thereof.

16. A computer readable medium having sequences of instructions stored therein, which when executed cause the processors in a plurality of computers that have been connected via a network to perform an organization management method, comprising:
integrating organization narrow system data and information via one or more operating system layers.

17. The computer readable medium of claim 16 where the method further comprises quantifying the value of each cell in market value matrix for the organization using said data and information.

18. The computer readable medium of claim 17 where the method further comprises providing the market value matrix to users and narrow systems via the operating system layer.

19. The computer readable medium of claim 18 where the method further comprises using the market value matrix to analyze, manage or optimize the organization financial impact of aspects of financial performance selected from the group consisting of elements of value, external factors, risks, segments of value, projects, enterprise, share price and combinations thereof.

20. The computer readable medium of claim 16 where the data and information are integrated using xmal and a common schema.
